(19) United States
(12) Patent Application Publication
(10) Pub. No.: US 2026/0133629 A1
(43) Pub. Date: May 14, 2026

(54) WEARABLE DEVICE, ELECTRONIC DEVICE CONNECTED TO WEARABLE DEVICE, AND METHOD FOR DRIVING SAME

(71) Applicant: Samsung Electronics Co., Ltd., Suwon-si (KR)

(72) Inventors: Junwhon UHM, Suwon-si (KR); Kwangtai KIM, Suwon-si (KR); Seungnyun KIM, Suwon-si (KR); Hongsuk KIM, Suwon-si (KR); Changrim YU, Suwon-si (KR); Jongmin YOON, Suwon-si (KR)

(21) Appl. No.: 19/370,124

(22) Filed: Oct. 27, 2025

Related U.S. Application Data
(63) Continuation of application No. PCT/KR2025/017080, filed on Oct. 24, 2025.

(30) Foreign Application Priority Data
Nov. 8, 2024 (KR) 10-2024-0158148
Jan. 8, 2025 (KR) 10-2025-0003027

(51) Int. Cl. G06F 3/01; G06F 3/14

(52) U.S. Cl. CPC G06F 3/013; G06F 3/14; G06F 3/012

(57) ABSTRACT

A wearable device, an electronic device connected to the wearable device, and a method for driving are provided. The wearable device includes one or more processors and memory storing instructions, wherein the instructions, when executed by the one or more processors individually or collectively, cause the wearable device to determine whether a state change of the wearable device has occurred using at least one sensor, determine at least one task to be executed in at least one external electronic device, and transmit information and a command related to the at least one task to the at least one external electronic device, so that the at least one external electronic device continuously executes at least a portion of the determined at least one task.

### CROSS-REFERENCE TO RELATED APPLICATION(S)

This application is a continuation application, claiming priority under 35 U.S.C. § 365(c), of an International application No. PCT/KR 2025/017080, filed on Oct. 24, 2025, which is based on and claims the benefit of a Korean patent application number 10-2024-0158148, filed on Nov. 8, 2024, in the Korean Intellectual Property Office, and of a Korean patent application number 10-2025-0003027, filed on Jan. 8, 2025, in the Korean Intellectual Property Office, the disclosure of each of which is incorporated by reference herein in its entirety.

### TECHNICAL FIELD

The disclosure relates to a wearable device, an electronic device connected to the wearable device, and a method for driving the same.

### BACKGROUND ART

With the recent development of technology, an electronic device is gradually evolving from a uniform rectangular shape to a variety of shapes. For example, the electronic device may include a wearable device that is wearable on a portion of the body. The wearable device may include a head-mounted display (HMD) that is wearable on a user's head. The wearable device may be referred to as a head-mount device (HMD), a headgear electronic device, a glasses-type electronic device, a video see-through or visible see-through (VST) device, an extended reality (XR) device, a virtual reality (VR) device, and/or an augmented reality (AR) device.

The above information is presented as background information only to assist with an understanding of the disclosure. No determination has been made, and no assertion is made, as to whether any of the above might be applicable as prior art with regard to the disclosure.

### DISCLOSURE OF INVENTION

Since the wearable device is a mobile device, a user may be restricted from continuing to use content depending on a remaining amount of a battery embedded in the wearable device. For example, when a problem in which a battery level of the wearable device is low occurs, the user may find it difficult to continuously use content through the wearable device.

Aspects of the disclosure are to address at least the above-mentioned problems and/or disadvantages and to provide at least the advantages described below. Accordingly, an aspect of the disclosure is to provide a wearable device, an electronic device connected to the wearable device, and a method for driving the same, which may improve user convenience by enabling the user to continuously use the content, which was being used through the wearable device, through another external device.

Additional aspects will be set forth in part in the description which follows and, in part, will be apparent from the description, or may be learned by practice of the presented embodiments.

In accordance with an aspect of the disclosure, a wearable device is provided. The wearable device includes one or more processors and memory storing instructions, wherein the instructions, when executed by the one or more processors individually or collectively, cause the wearable device to determine whether a state change of the wearable device has occurred using at least one sensor, determine at least one task to be executed in at least one external electronic device, and transmit information and a command related to the at least one task to the at least one external electronic device, so that the at least one external electronic device continuously executes at least a portion of the determined at least one task.

In accordance with another aspect of the disclosure, an electronic device is provided. The electronic device includes one or more processors and memory storing instructions, wherein the instructions, when executed by the one or more processors individually or collectively, cause the electronic device to receive information and a command related to at least one task being executed by the wearable device from the wearable device, display at least a portion of the information related to the at least one task, select one task from among the at least one task in response to a user input, execute the selected task, and display a screen related to the executed task.

In accordance with another aspect of the disclosure, a method performed by a wearable device is provided. The method includes determining whether a state change of the wearable device has occurred using at least one sensor, determining at least one task to be executed in at least one external electronic device, and transmitting information and a command related to the at least one task to the at least one external electronic device, so that the at least one external electronic device continuously executes at least a portion of the determined at least one task.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include determining whether a state change of the wearable device has occurred using at least one sensor, determining at least one task to be executed in at least one external electronic device, and transmitting information and a command related to the at least one task to the at least one external electronic device, so that the at least one external electronic device continuously executes at least a portion of the determined at least one task.

According to embodiments of the disclosure, user convenience may be enhanced by allowing content being used by a user through a wearable device to be continuously used through another external device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates an example of a perspective view of a wearable device according to an embodiment of the disclosure;

FIG. 2B illustrates an example of one or more hardware components disposed in the wearable device according to an embodiment of the disclosure;

FIGS. 3A and 3B illustrate an example of an external appearance of the wearable device according to various embodiments of the disclosure;

FIG. 4 illustrates an example of a block diagram of the wearable device according to an embodiment of the disclosure;

FIG. 5 illustrates an example of a block diagram of the wearable device for displaying an image in a virtual space according to an embodiment of the disclosure;

FIG. 6 illustrates an example of a structure of a plurality of layers according to an embodiment of the disclosure;

FIG. 7 is a flowchart illustrating a method for driving the wearable device according to an embodiment according to an embodiment of the disclosure;

FIG. 8 is a conceptual diagram illustrating a method for driving the wearable device according to an embodiment according to an embodiment of the disclosure;

FIG. 9 is a flowchart illustrating a method in which the wearable device delivers a task according to an embodiment according to an embodiment of the disclosure;

FIG. 10 is a diagram illustrating a case in which an external electronic device displays a popup notification according to an embodiment of the disclosure;

FIG. 11 is a flowchart illustrating a method in which the wearable device delivers a task according to an embodiment of the disclosure;

FIG. 12 is a diagram illustrating a case in which the wearable device receives a user input according to an embodiment of the disclosure;

FIG. 13 is a diagram illustrating a layout in which an external electronic device displays a received task according to an embodiment of the disclosure;

FIG. 14 is a flowchart illustrating an operation of the wearable device when the wearable device is in a low battery state according to an embodiment of the disclosure;

FIG. 15 is a flowchart illustrating an operation of the wearable device when the wearable device executes a task requiring high performance according to an embodiment of the disclosure;

FIG. 16 is a diagram illustrating a notification indicating an expected execution time of a task requiring high performance according to an embodiment of the disclosure;

FIG. 17 illustrates an example of a mixed reality space including augmented reality or virtual reality provided by the wearable device according to an embodiment of the disclosure;

FIG. 18 is a diagram illustrating a notification indicating an execution state of a task according to an embodiment of the disclosure;

FIG. 19 is a diagram illustrating an operation of the wearable device when detachment of the wearable device by a user is detected according to an embodiment of the disclosure;

FIG. 20 is a flowchart illustrating a method for driving the wearable device according to an embodiment of the disclosure; and

FIG. 21 is a flowchart illustrating a method for driving the electronic device according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

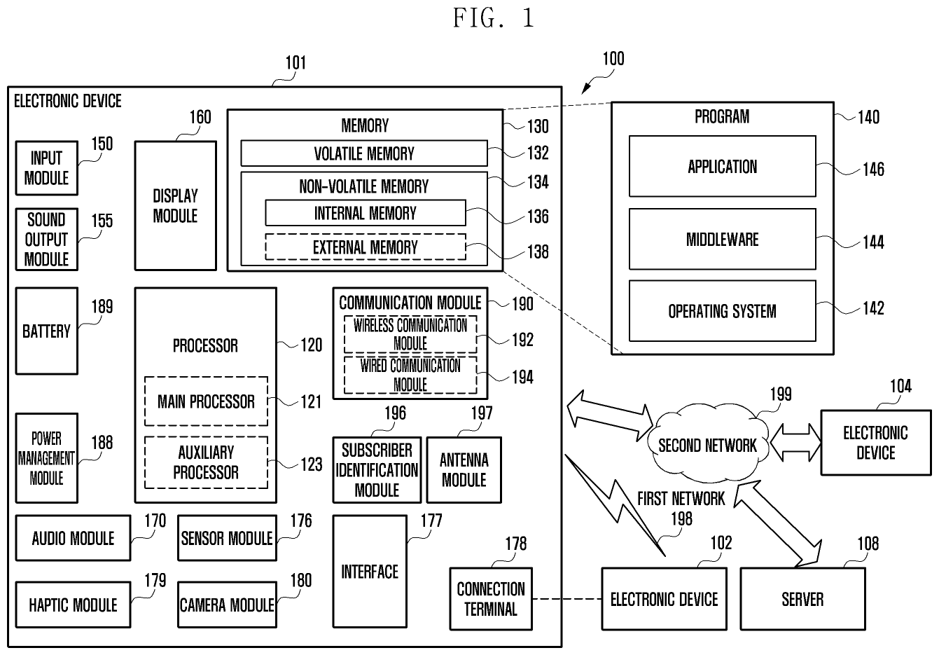

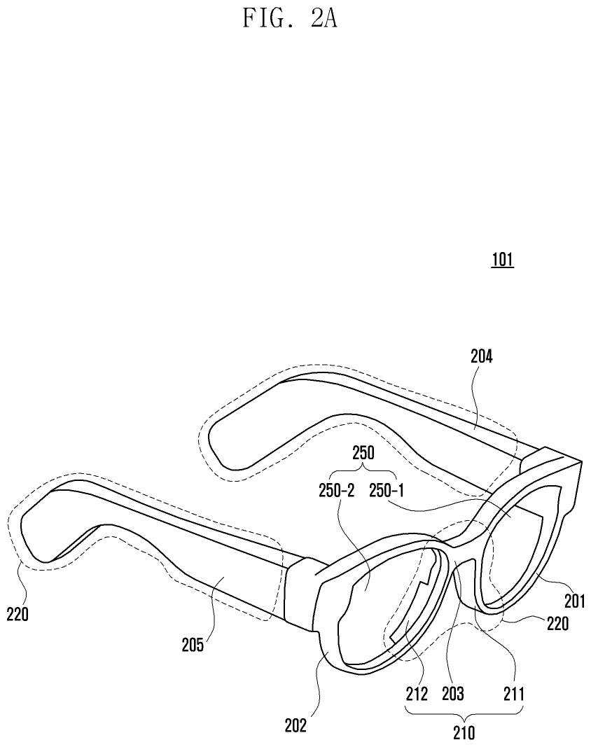

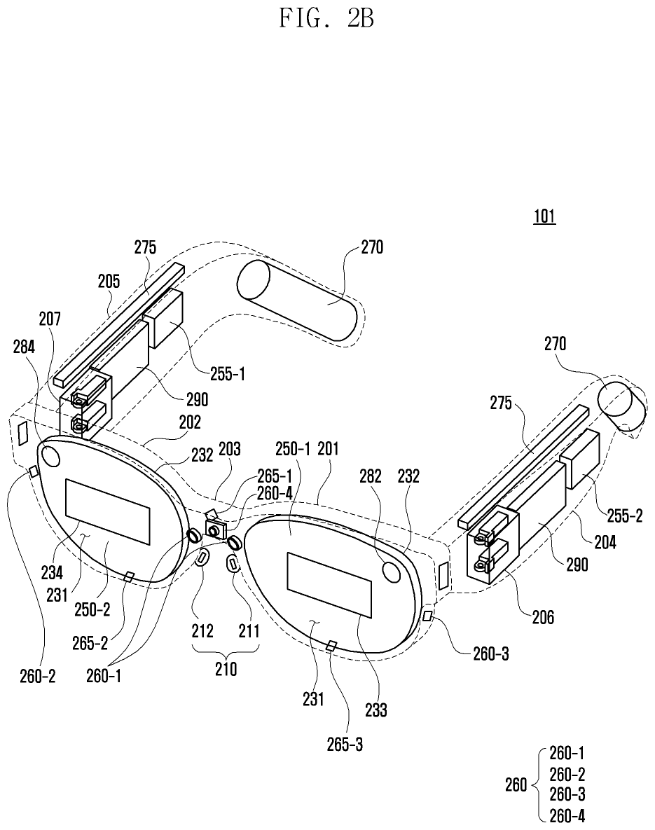

Each of the embodiments described with reference to the drawings of the disclosure may be configured independently as a single embodiment. For example, each of the embodiment in FIG. 1 and the embodiment in FIGS. 2A and 2B may be configured independently from each other. Each of the embodiments described with reference to the drawings of the disclosure may operate independently as a single embodiment. For example, each of the embodiment in FIG. 1 and the embodiment in FIGS. 2. 2A and 2B may operate independently from each other.

At least two of the embodiments described with reference to the drawings of the disclosure may be combined and configured. For example, at least a part of the embodiment in FIG. 1 and at least a part of the embodiment in FIGS. 2A and 2B may be combined with each other and configured. At least two of the embodiments described with reference to the drawings of the disclosure may be combined and operated. For example, at least a part of the embodiment in FIG. 1 and at least a part of the embodiment in FIGS. 2A and 2B may be combined with each other and operated.

When at least two of the embodiments described with reference to the drawings of the disclosure are combined, at least a part of the configuration and/or at least a part of the operation included in each embodiment may be omitted. For example, when the embodiment in FIG. 1 and the embodiment in FIGS. 2A and 2B are combined, at least a part of the configuration and/or at least a part of the operation included in the embodiment in FIG. 1 may be omitted, and at least a part of the configuration and/or at least a part of the operation included in the embodiment in FIGS. 2A and 2B may be omitted.

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

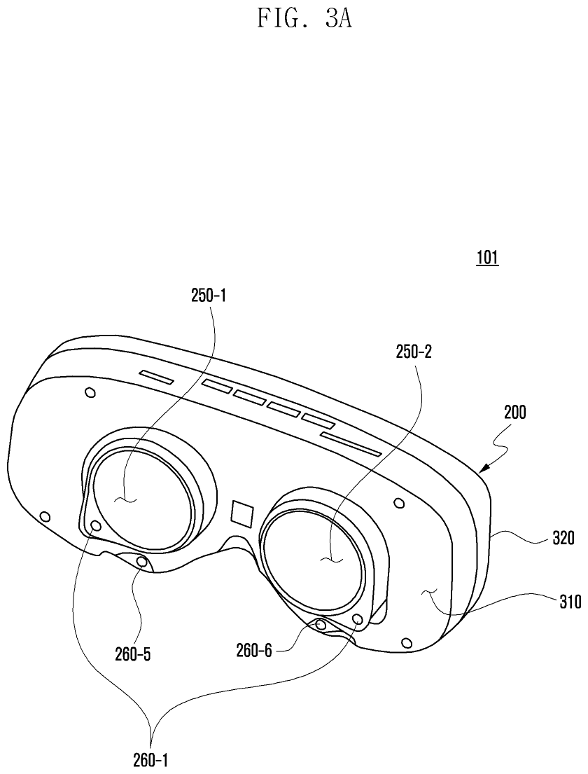

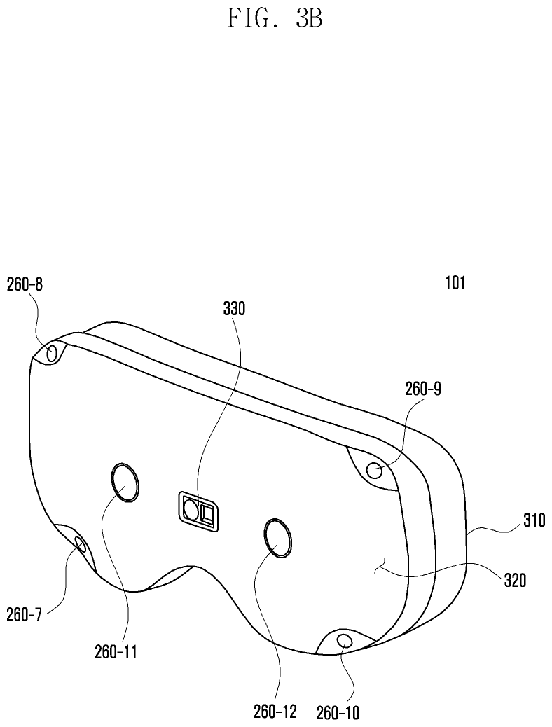

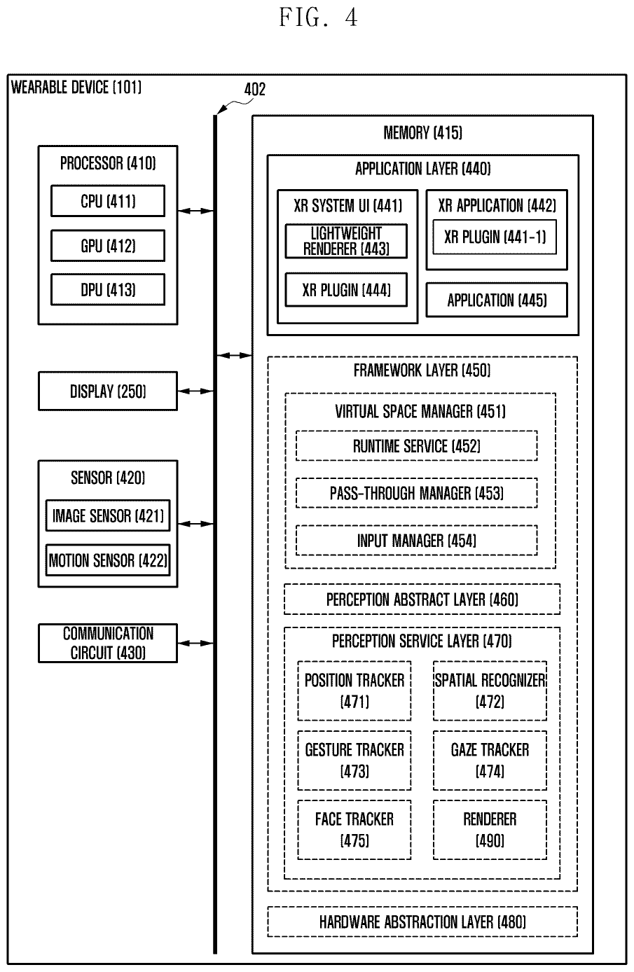

In the embodiments of the disclosure, an electronic device (e.g., electronic device 101 in FIG. 1) for displaying an image in a virtual space may be a wearable device. The wearable device 101 may include a head-mounted display (HMD) that is wearable on a user's head. The wearable device 101 may be referred to as a head-mount device (HMD), a headgear electronic device, a glasses-type electronic device, a video see-through or visible see-through (VST) device, an extended reality (XR) device, a virtual reality (VR) device, and/or an augmented reality (AR) device. Although an external shape of the wearable device 101 having a glasses-type form is illustrated, the embodiment is not limited thereto. An example of a hardware configuration included in the wearable device 101 is described with reference to FIG. 4. An example of a structure of the wearable device 101 that is wearable on a user 110's head is described with reference to FIGS. 2A, 2B, 3A, and/or 3B. The wearable device 101 may be referred to as an electronic device. For example, the electronic device may be combined with an accessory (e.g., a strap) to be attached to the user's head, and may form an HMD.

The wearable device 101 according to an embodiment may execute functions related to augmented reality (AR) and/or mixed reality (MR). For example, in a state in which the user 110 wears the wearable device 101, the wearable device 101 may include at least one lens disposed adjacent to the user's 110 eyes. The wearable device 101 may combine light emitted from a display of the wearable device 101 with ambient light passing through the lens. A displaying area of the display may be formed within the lens through which the ambient light passes. Since the wearable device 101 combines the ambient light and the light emitted from the display, the user 110 may see an image in which a real object, recognized by the ambient light, and a virtual object, formed by the light emitted from the display, are mixed. The above-described augmented reality, mixed reality, and/or virtual reality may be referred to as extended reality (XR).

The wearable device 101 according to an embodiment may execute functions related to video see-through or visible see-through (VST) and/or virtual reality (VR). For example, in a state in which the user 110 wears the wearable device 101, the wearable device 101 may include a housing covering the user 110's eyes. The wearable device 101, in the above state, may include a display disposed on a first surface of the housing facing the eyes. The wearable device 101 may include a camera disposed on a second surface opposite to the first surface. Using the camera, the wearable device 101 may acquire an image and/or a video representing ambient light. The wearable device 101 may output the image and/or the video, within the display disposed on the first surface, so that the user 110 may recognize the ambient light through the display. A displaying area (or displaying region) (or active area or active region) of the display disposed on the first surface may be formed by one or more pixels included in the display. The wearable device 101 may synthesize a virtual object into the image and/or the video output through the display, so that the user 110 may recognize the virtual object together with a real object recognized by the ambient light.

The wearable device 101 according to an embodiment may identify or recognize a position (or location) and/or a direction (or orientation) of the wearable device 101 based on an image (and/or a video) obtained (or acquired) using the camera. The wearable device 101 may acquire information on the external space using one or more cameras and/or one or more sensors. The information may include a geographic location (e.g., global positioning system (GPS) coordinates) of the external space, identified from one or more sensors. The information may include an image and/or a video of the external space, identified from one or more cameras. The wearable device 101 may perform object recognition on the image and/or the video, and may identify external objects included in the external space, from the image and/or the video.

Referring to FIGS. 2A, 2B, 3A, 3B, and 4, an example of a hardware configuration of the wearable device 101 is described.

FIG. 2A illustrates an example of a perspective view of a wearable device according to an embodiment of the disclosure.

FIG. 2B illustrates an example of one or more hardware components disposed in the wearable device according to an embodiment of the disclosure.

According to an embodiment, the wearable device 101 may have a glasses-type form that is wearable on a portion of a user's body (e.g., the head). The wearable device 101 in FIGS. 2A and 2B may be an example of the wearable device 101 in FIG. 1. The wearable device 101 may include a head-mounted display (HMD). For example, a housing of the wearable device 101 may include a flexible material, such as rubber and/or silicone, having a form closely attached to a portion of the user's head (e.g., a portion of the face surrounding both eyes). For example, a housing of the wearable device 101 may include one or more straps able to be twined around the user's head and/or one or more temples attachable to ears of the head.

Referring to FIG. 2A, according to an embodiment, the wearable device 101 may include at least one display 250 and a frame 200 supporting the at least one display 250.

According to an embodiment, the wearable device 101 may be worn on a portion of the user's body. The wearable device 101 may provide augmented reality (AR), virtual reality (VR), or mixed reality (MR) combining augmented reality and virtual reality, to a user wearing the wearable device 101. For example, the wearable device 101 may display a virtual reality image, provided from at least one optical device 282 or 284 in FIG. 2B, on at least one display 250, in response to a designated gesture of the user acquired through motion recognition cameras 260-2 or 260-3 in FIG. 2B.

According to an embodiment, at least one display 250 may provide visual information to the user. For example, at least one display 250 may include a transparent or semi-transparent lens. At least one display 250 may include a first display 250-1 and/or a second display 250-2 spaced apart from the first display 250-1. For example, the first display 250-1 and the second display 250-2 may be disposed at positions respectively corresponding to a left eye and a right eye of the user.

Referring to FIG. 2B, at least one display 250 may provide to a user visual information delivered from external light through a lens included in the at least one display 250, and other visual information distinguished from the visual information. The lens may be formed based on at least one of a fresnel lens, a pancake lens, or a multi-channel lens. For example, at least one display 250 may include a first surface 231 and a second surface 232 opposite to the first surface 231. On the second surface 232 of the at least one display 250, a displaying area may be formed. When the user wears the wearable device 101, external light may be incident on the first surface 231, and may be transmitted through the second surface 232, and thereby delivered to the user. In another example, at least one display 250 may display, in a displaying area formed on the second surface 232, an augmented reality image in which a virtual reality image provided from at least one optical device 282 or 284 is combined with a real-world screen delivered through the external light.

In an embodiment, at least one display 250 may include at least one waveguide 233 or 234 that diffracts light transmitted from at least one optical device 282 or 284, and delivers the light to the user. At least one waveguide 233 or 234 may be formed based on at least one of glass, plastic, or polymer. On at least a portion of an outside or an inside of the at least one waveguide 233 or 234, a nano pattern may be formed. The nano pattern may be formed based on a grating structure having a polygonal and/or curved shape. Light incident on one end of the at least one waveguide 233 or 234 may be propagated to the other end of the at least one waveguide 233 or 234 by the nano pattern. The at least one waveguide 233 or 234 may include at least one of a diffractive element (e.g., diffractive optical element (DOE) or holographic optical element (HOE)) or a reflective element (e.g., reflective mirror). For example, at least one waveguide 233 or 234 may be disposed in the wearable device 101 to guide a screen displayed by at least one display 250 to the user's eyes. For example, the screen may be transmitted to the user's eyes based on total internal reflection (TIR) occurring in the at least one waveguide 233 or 234.

The wearable device 101 may analyze an object included in a real-world image collected through a photographing camera 260-4, and may combine a virtual object corresponding to an object targeted for providing augmented reality among the analyzed objects, and display the virtual object on at least one display 250. The virtual object may include at least one of text and image regarding various types of information related to the object included in the real-world image. The wearable device 101 may analyze the object based on a multi-camera, such as a stereo camera. For the object analysis, the wearable device 101 may execute spatial recognition (e.g., simultaneous localization and mapping (SLAM)) using a multi-camera and/or time-of-flight (ToF). A user wearing the wearable device 101 may view an image displayed on at least one display 250.

According to an embodiment, the frame 200 may be formed of a physical structure such that the wearable device 101 may be worn on the user's body. According to an embodiment, the frame 200 may be configured such that, when the user wears the wearable device 101, the first display 250-1 and the second display 250-2 may be positioned corresponding to the user's left and right eyes. The frame 200 may support at least one display 250. For example, the frame 200 may support the first display 250-1 and the second display 250-2 to be positioned at positions corresponding to the user's left and right eyes.

Referring to FIG. 2A, when the user wears the wearable device 101, the frame 200 may include an area 220 in which at least a portion is in contact with a portion of the user's body. For example, the area 220, which is in contact with a portion of the user's body in the frame 200, may include an area in contact with a portion of the user's nose, a portion of the user's ears, and a portion of side surface of the user's face, which are touched by the wearable device 101. According to an embodiment, the frame 200 may include a nose pad 210 that is in contact with a portion of the user's body. When the wearable device 101 is worn by the user, the nose pad 210 may be in contact with a portion of the user's nose. The frame 200 may include a first temple 204 and a second temple 205 that are in contact with other portions of the user's body, distinguished from the part of the user's body.

For example, the frame 200 may include a first rim 201a surrounding at least a portion of the first display 250-1, a second rim 202 surrounding at least a portion of the second display 250-2, a bridge 203 disposed between the first rim 201 and the second rim 202, a first pad 211 disposed along a portion of an edge of the first rim 201 from one end of the bridge 203, a second pad 212 disposed along a portion of an edge of the second rim 202 from the other end of the bridge 203, a first temple 204 extending from the first rim 201 and fixed to a portion of the user's ear, and a second temple 205 extending from the second rim 202 and fixed to a portion of the opposite ear. The first pad 211 and the second pad 212 may be in contact with a portion of the user's nose, and the first temple 204 and the second temple 205 may be in contact with a portion of the user's face and a portion of the user's ears. The temples 204 and 205 may be rotatably connected to the rims via hinge units 206 and 207 in FIG. 2B. The first temple 204 may be rotatably connected to the first rim 201 via a first hinge unit 206 disposed between the first rim 201 and the first temple 204. The second temple 205 may be rotatably connected to the second rim 202 via a second hinge unit 207 disposed between the second rim 202 and the second temple 205. According to an embodiment, the wearable device 101 may identify an external object (e.g., a user's fingertip) touching the frame 200, and/or a gesture performed by the external object, using a touch sensor, a grip sensor, and/or a proximity sensor formed on at least a portion of a surface of the frame 200.

According to an embodiment, the wearable device 101 may include hardware components performing various functions (e.g., hardware components described later based on the block diagram of FIG. 4). For example, the hardware components may include a battery module 270, an antenna module 275, at least one optical device 282 or 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). The various hardware components may be disposed in the frame 200.

According to an embodiment, a microphone (e.g., microphones 265-1, 265-2, and 265-3) of the wearable device 101 may be disposed in at least a portion of the frame 200 to acquire a sound signal. Although a first microphone 265-1 disposed on the bridge 203, a second microphone 265-2 disposed on the second rim 202, and a third microphone 265-3 disposed on the first rim 201 are illustrated in FIG. 2B, the number and disposition of the microphones 265 are not limited to the embodiment in FIG. 2B. When the number of microphones 265 included in the wearable device 101 is two or more, the wearable device 101 may identify a direction of a sound signal using the plurality of microphones disposed on different parts of the frame 200.

According to an embodiment, at least one optical device 282 or 284 may project a virtual object onto at least one display 250 to provide various image information to the user. For example, at least one optical device 282 or 284 may be a projector. At least one optical device 282 or 284 may be disposed adjacent to at least one display 250, or may be included within at least one display 250 as a portion of at least one display 250. According to an embodiment, the wearable device 101 may include a first optical device 282 corresponding to the first display 250-1 and a second optical device 284 corresponding to the second display 250-2. For example, at least one optical device 282 or 284 may include the first optical device 282 disposed at an edge of the first display 250-1, and the second optical device 284 disposed at an edge of the second display 250-2. The first optical device 282 may transmit light to a first waveguide 233 disposed on the first display 250-1, and the second optical device 284 may transmit light to a second waveguide 234 disposed on the second display 250-2.

In an embodiment, a camera 260 may include a photographing camera 260-4, an eye tracking camera (ET CAM) 260-1, and/or a motion recognition camera 260-2 or 260-3. The photographing camera 260-4, the eye tracking camera 260-1, and the motion recognition cameras 260-2 and 260-3 may be disposed at different positions on the frame 200, and may perform different functions. The eye tracking camera 260-1 may output data indicating a position of the eyes or a gaze of the user wearing the wearable device 101. For example, the wearable device 101 may detect the gaze from an image including the user's eyeballs, acquired through the eye tracking camera 260-1. The wearable device 101 may identify an object (e.g., a real object and/or a virtual object) focused on by the user using the gaze acquired through the eye tracking camera 260-1. The wearable device 101, which has identified a focused object, may execute a function (e.g., gaze interaction) for interaction between the user and the focused object. The wearable device 101 may represent a portion corresponding to eyes of an avatar, representing the user in a virtual space, using a gaze of the user acquired through the eye tracking camera 260-1. The wearable device 101 may render an image (or screen) displayed on at least one display 250, based on a position of the user's eyes. For example, visual quality of a first area related to the gaze within the image, and visual quality of a second area distinguished from the first area (e.g., resolution, brightness, saturation, grayscale, PPI) may differ from each other. The wearable device 101 may acquire an image having visual quality of the first area matching the user's gaze and visual quality of the second area, using foveated rendering. For example, when the wearable device 101 supports an iris recognition function, the wearable device 101 may perform user authentication based on iris information acquired using the eye tracking camera 260-1. Although an example in which the eye tracking camera 260-1 is disposed toward the user's right eye is illustrated in FIG. 2B, the embodiment is not limited thereto, and the eye tracking camera 260-1 may be disposed solely toward the user's left eye, or may be disposed toward both eyes.

In an embodiment, the photographing camera 260-4 may photograph a real image or background, which is to be matched with a virtual image, to implement augmented reality or mixed reality content. The photographing camera 260-4 may be used to acquire a high-resolution image, based on high resolution (HR) or photo video (PV). The photographing camera 260-4 may photograph an image of a specific object present at a position viewed by the user, and may provide the image to at least one display 250. At least one display 250 may display a single image, in which information on a real image or background including the image of the specific object acquired using the photographing camera 260-4, and a virtual image provided through at least one optical device 282 or 284, are superimposed. The wearable device 101 may compensate for depth information (e.g., distance between the wearable device 101 and an external object acquired through a depth sensor) using the image acquired through the photographing camera 260-4. The wearable device 101 may perform object recognition through the image acquired using the photographing camera 260-4. The wearable device 101 may perform a function (e.g., auto focus) to focus on an object (or subject) in the image, and/or an optical image stabilization (OIS) function (e.g., shake prevention function) using the photographing camera 260-4. The wearable device 101, while displaying a screen representing a virtual space on at least one display 250, may perform a pass-through function to display an image, acquired through the photographing camera 260-4, overlaid on at least a portion of the screen. In an embodiment, the photographing camera 260-4 may be disposed on the bridge 203 disposed between the first rim 201 and the second rim 202.

The eye tracking camera 260-1, by tracking a gaze of a user wearing the wearable device 101, may implement a more realistic augmented reality by matching the user's gaze and visual information provided to at least one display 250. For example, the wearable device 101 may naturally display environmental information related to the front of the user at the place where the user is positioned, to at least one display 250, when the user looks forward. The eye tracking camera 260-1 may be configured to capture an image of the user's pupil to determine the user's gaze. For example, the eye tracking camera 260-1 may receive gaze detection light reflected from the user's pupil, and may track the user's gaze based on a position and movement of the received gaze detection light. In an embodiment, the eye tracking camera 260-1 may be disposed at positions corresponding to the user's left eye and right eye. For example, the eye tracking camera 260-1 may be disposed within the first rim 201 and/or the second rim 202 so as to face toward a direction in which the user wearing the wearable device 101 is positioned.

The motion recognition cameras 260-2 and 260-3, by recognizing movement of a whole or partial body of the user, such as the torso, hand, or face of the user, may provide a specific event on a screen provided to at least one display 250. The motion recognition cameras 260-2 and 260-3 may recognize a user's motion (gesture recognition), acquire a signal corresponding to the motion, and provide a display corresponding to the signal to at least one display 250. The processor may identify the signal corresponding to the motion, and may perform a designated function based on the identification. The motion recognition cameras 260-2 and 260-3 may be used to perform a spatial recognition function using SLAM for six degrees of freedom pose (6 dof pose) and/or a depth map. The processor may perform a gesture recognition function and/or an object tracking function using the motion recognition cameras 260-2 and 260-3. In an embodiment, the motion recognition cameras 260-2 and 260-3 may be disposed on the first rim 201 and/or the second rim 202.

The camera 260 included in the wearable device 101 is not limited to the above-described eye tracking camera 260-1 and motion recognition cameras 260-2 and 260-3. For example, the wearable device 101 may identify an external object included in a field of view (FoV) using a camera disposed toward the user's FoV. The identification of the external object by the wearable device 101 may be performed based on a sensor configured to identify a distance between the wearable device 101 and the external object, such as a depth sensor and/or time-of-flight (ToF) sensor. The camera 260 disposed toward the FoV may support an auto focus function and/or an optical image stabilization (OIS) function. For example, the wearable device 101 may include the camera 260 (e.g., a face tracking (FT) camera) disposed toward a face in order to acquire an image including the face of a user wearing the wearable device 101.

Although not illustrated, the wearable device 101 according to an embodiment may further include a light source (e.g., an LED) that emits light toward a subject (e.g., a user's eye, face, and/or an external object within the FoV) captured using the camera 260. The light source may include an LED of infrared wavelength. The light source may be disposed in at least one of the frame 200 and the hinge units 206 and 207.

In an embodiment, the battery module 270 may supply power to electronic components of the wearable device 101. In an embodiment, the battery module 270 may be disposed within the first temple 204 and/or the second temple 205. For example, the battery module 270 may be a plurality of battery modules 270. The plurality of battery modules 270 may be respectively disposed in the first temple 204 and the second temple 205. In an embodiment, the battery module 270 may be disposed at an end portion of the first temple 204 and/or the second temple 205.

The antenna module 275 may transmit a signal or power to an outside of the wearable device 101, or may receive a signal or power from the outside. In an embodiment, the antenna module 275 may be disposed within the first temple 204 and/or the second temple 205. For example, the antenna module 275 may be disposed close to one surface of the first temple 204 and/or the second temple 205.

The speaker 255 may output an audio signal to the outside of the wearable device 101. An audio output module may be referred to as a speaker. In an embodiment, the speaker 255 may be disposed within the first temple 204 and/or the second temple 205 to be disposed adjacent to the ear of a user wearing the wearable device 101. For example, the speaker 255 may include a second speaker 255-2 disposed within the first temple 204 to be disposed adjacent to the user's left ear, and a first speaker 255-1 disposed within the second temple 205 to be disposed adjacent to the user's right ear.

The light emitting module (not illustrated) may include at least one light emitting element. The light emitting module may emit light of a color corresponding to a specific state, or may emit light in a motion corresponding to a specific state, in order to visually provide information on the specific state of the wearable device 101 to a user. For example, when the wearable device 101 needs to be charged, it may emit red light at regular intervals. In an embodiment, the light emitting module may be disposed on the first rim 201 and/or the second rim 202.

Referring to FIG. 2B, the wearable device 101 according to an embodiment may include a printed circuit board (PCB) 290. The PCB 290 may be included in at least one of the first temple 204 or the second temple 205. The PCB 290 may include an interposer disposed between at least two sub-PCBs. On the PCB 290, one or more hardware components included in the wearable device 101 (e.g., hardware components illustrated by different blocks in FIG. 4) may be disposed. The wearable device 101 may include a flexible PCB (FPCB) for interconnecting the hardware components.

In an embodiment, the wearable device 101 may include at least one of a gyro sensor, a gravity sensor, and/or an acceleration sensor for detecting a pose of the wearable device 101, and/or a pose of a body part (e.g., a head) of a user wearing the wearable device 101. Each of the gravity sensor and the acceleration sensor may measure gravitational acceleration and/or acceleration based on designated three-dimensional axes (e.g., x-axis, y-axis, and z-axis) that are perpendicular to one another. The gyro sensor may measure angular velocities for each of the designated three-dimensional axes (e.g., x-axis, y-axis, and z-axis). At least one of the gravity sensor, the acceleration sensor, or the gyro sensor may be referred to as an inertial measurement unit (IMU). The wearable device 101 according to an embodiment may identify a motion and/or a gesture performed by a user in order to execute or suspend a specific function of the wearable device 101 based on the IMU.

FIGS. 3A and 3B illustrate an example of an external appearance of a wearable device (e.g., wearable device 101) according to various embodiments of the disclosure.

The wearable device 101 in FIGS. 3A and 3B may be an example of the wearable device 101 in FIG. 1. An example of an external appearance of a first surface 310 of a housing of the wearable device 101 according to an embodiment is illustrated in FIG. 3A, and an example of an external appearance of a second surface 320, opposite to the first surface 310, may be illustrated in FIG. 3B.

Referring to FIG. 3A, the first surface 310 of the wearable device 101 according to an embodiment may have a form attachable to a body part (e.g., the face of the user) of a user. Although not illustrated, the wearable device 101 may further include a strap, and/or one or more temples (e.g., the first temple 204 and/or the second temple 205 in FIGS. 2A and 2B) for being fixed on a body part of a user. The first display 250-1 for outputting an image to a left eye among both eyes of the user, and the second display 250-2 for outputting an image to a right eye among both eyes of the user may be disposed on the first surface 310. The wearable device 101 may further include packing made of rubber or silicon formed on the first surface 310, for preventing interference caused by light (e.g., ambient light) different from light emitted from the first display 250-1 and the second display 250-2.

The wearable device 101 according to an embodiment may include cameras 260-1 for capturing and/or tracking both eyes of the user, which are adjacent to each of the first display 250-1 and the second display 250-2. The cameras 260-1 may be referred as the eye tracking camera 260-1 in FIG. 2B. The wearable device 101 according to an embodiment may include cameras 260-5 and 260-6 for capturing and/or recognizing a face of the user. The cameras 260-5 and 260-6 may be referred to as FT cameras. The wearable device 101 may control an avatar representing the user in a virtual space, based on a movement (motion) of the face of the user identified using the cameras 260-5 and 260-6. For example, the wearable device 101 may change a texture and/or a form of a portion of the avatar (e.g., a portion of the avatar representing a human face), using information representing facial expressions of the user wearing the wearable device 101, acquired by the cameras 260-5 and 260-6 (e.g., FT cameras).

Referring to FIG. 3B, on the second surface 320 opposite to the first surface 310 in FIG. 3A, cameras (e.g., cameras 260-7, 260-8, 260-9, 260-10, 260-11, and 260-12) and/or a sensor (e.g., a depth sensor 330) for acquiring information related to an external environment of the wearable device 101 may be disposed. For example, the cameras 260-7, 260-8, 260-9, and 260-10 may be disposed on the second surface 320 in order to recognize an external object. The cameras 260-7, 260-8, 260-9, and 260-10 may be referred as the motion recognition cameras 260-2 and 260-3 in FIG. 2B.

By using the cameras 260-11 and 260-12, the wearable device 101 may acquire an image and/or a video to be transmitted to each of the user's both eyes. The camera 260-11 may be disposed on the second surface 320 of the wearable device 101 so as to acquire an image to be displayed through the second display 250-2, corresponding to a right eye among both eyes. The camera 260-12 may be disposed on the second surface 320 of the wearable device 101 so as to acquire an image to be displayed through the first display 250-1, corresponding to a left eye among both eyes. The cameras 260-11 and 260-12 may be referred as the photographing camera 260-4 in FIG. 2B.

In an embodiment, the wearable device 101 may include a depth sensor 330 disposed on the second surface 320, in order to identify a distance between the wearable device 101 and an external object. By using the depth sensor 330, the wearable device 101 may acquire spatial information (e.g., a depth map) for at least a portion of the FoV of the user wearing the wearable device 101. Although not illustrated, on the second surface 320 of the wearable device 101, a microphone for acquiring a sound output from an external object may be disposed. The number of microphones may be one or more according to an embodiment.

Referring to FIG. 4, a hardware or software configuration of the wearable device 101 will be described.

FIG. 4 illustrates an example of a block diagram of a wearable device (e.g., the wearable device 101) according to an embodiment of the disclosure.

The wearable device 101 in FIG. 4 may be an example of the electronic device 101 in FIG. 1, and an example of the wearable device 101 in FIGS. 2A, 2B, 3A, and 3B.

Referring to FIG. 4, the wearable device 101 according to an embodiment may include a processor 410 (e.g., the processor 120), memory 415, a display 250 (e.g., the first display 250-1 and/or the second display 250-2 in FIGS. 2A, 2B, 3A, and 3B), a sensor 420 (e.g., an image sensor 421 and/or a motion sensor 422), and/or a communication circuit 430 (e.g., including at least a portion of the communication module 190 in FIG. 1). The processor 410, the memory 415, the display 250, the sensor 420, and/or the communication circuit 430 may be electrically and/or operatively connected to each other by means of an electronic component such as a communication bus 402. In the disclosure, an operative connection of electronic components may include a direct connection established between the electronic components and/or an indirect connection established between the electronic components, such that a first electronic component among the electronic components is controlled by a second electronic component among the electronic components. A type and/or the number of electronic components included in the wearable device 101 may not be limited to those illustrated in FIG. 4. For example, the wearable device 101 may include only some of the electronic components illustrated in FIG. 4.

The processor 410 of the wearable device 101 according to an embodiment may include a circuit (e.g., a processing circuit) for processing data based on one or more instructions. The circuit for processing data may include, for example, an arithmetic and logic unit (ALU), a field programmable gate array (FPGA), a central processing unit (CPU), and/or an application processor (AP). In an embodiment, the wearable device 101 may include one or more processors. The processor 410 may have a multi-core processor structure such as a dual core, a quad core, a hexa core, and/or an octa core. The multi-core processor structure of the processor 410 may include a structure (e.g., a big-little structure) based on a plurality of core circuits distinguished by power consumption, clock, and/or a calculation amount per unit time. In an embodiment including the processor 410 having the multi-core processor structure, operations and/or functions of the disclosure may be individually or collectively performed by one or more cores included in the processor 410.

The memory 415 of the wearable device 101 according to an embodiment may include an electronic component for storing data and/or instructions input to the processor 410, and/or output from the processor 410. The memory 415 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disc, or an embedded multimedia card (eMMC). In an embodiment, the memory 415 may be referred to as a storage.

In an embodiment, the display 250 of the wearable device 101 may output visualized information to a user of the wearable device 101. The display 250, which is arranged in front of the eyes of the user wearing the wearable device 101, may be disposed in at least a portion of the housing of the wearable device 101 (e.g., the first display 250-1 and/or the second display 250-2 in FIGS. 2A, 2B, 3A, and 3B). For example, the display 250 may be included in a display assembly. For example, the display 250 may be controlled by the processor 410, which includes circuits such as a CPU 411, a graphics processing unit (GPU) 412, and/or a display processing unit (DPU) 413, and may output visualized information to the user. The display 250 may include a flexible display, a flat panel display (FPD), and/or electronic paper. The display 250 may include a liquid crystal display (LCD), a plasma display panel (PDP), and/or one or more light emitting diodes (LEDs). The LED may include an organic light emitting diode (OLED). The embodiments are not limited thereto, and for example, in case that the wearable device 101 includes a lens for transmitting external light (or ambient light), the display 250 may include a projector (or projection assembly) for projecting light onto the lens. In an embodiment, the display 250 may be referred to as a display panel and/or a display module. Pixels included in the display 250 may be disposed toward either one of both eyes of the user when the wearable device 101 is worn by the user. For example, the display 250 may include displaying areas (or active areas) corresponding to each of both eyes of the user.

In an embodiment, the sensor 420 of the wearable device 101 may generate electronic information that may be processed by the processor 410 and/or the memory 415 from non-electronic information related to the wearable device 101. For example, the sensor 420 may include a global positioning system (GPS) sensor for detecting the geographic location of the wearable device 101. In addition to the GPS method, the sensor 420 may generate information indicating the geographic location of the wearable device 101 based on a global navigation satellite system (GNSS) such as Galileo and Beidou (Compass). The above information may be stored in the memory 415, processed by the processor 410, and/or transmitted to another electronic device distinguished from the wearable device 101 through a communication circuit.

Referring to FIG. 4, as an example of the sensor 420 included in the wearable device 101, an image sensor 421 and/or a motion sensor 422 is illustrated. The sensor 420 may include one or more light sensors (e.g., a charged coupled device (CCD) sensor, a complementary metal oxide semiconductor (CMOS) sensor) that generate an electrical signal indicating the color and/or brightness of light. The image sensor 421 may be referred to as a camera. A plurality of light sensors included in the image sensor 421 may be disposed in a two-dimensional grid (four-dimensional array). The image sensor 421 may acquire electrical signals of each of the plurality of light sensors substantially simultaneously, and may generate two-dimensional frame data corresponding to light that has reached the light sensors in the two-dimensional grid. For example, photo data captured using the image sensor 421 may mean one two-dimensional frame data acquired from the image sensor 421. For example, video data captured using the image sensor 421 may mean a sequence of a plurality of two-dimensional frame data acquired from the image sensor 421 according to a frame rate. The image sensor 421 may be disposed toward a direction in which the image sensor 421 receives light, and further include a flashlight for outputting light toward the direction.

According to an embodiment, the wearable device 101 may include a plurality of image sensors disposed toward different directions, as an example of the image sensor 421. As described above with reference to FIGS. 2A, 2B, 3A, and 3B, the plurality of image sensors may include a gaze tracking camera (e.g., the gaze tracking camera 260-1 in FIGS. 2B and 3A) configured to be arranged toward the eyes of the user wearing the wearable device 101. The plurality of image sensors may include outward cameras. The processor 410 may identify the gaze direction of the user by using the image and/or video acquired from the gaze tracking camera. The gaze tracking camera may include an infrared (IR) sensor. The gaze tracking camera may be referred to as an eyeball sensor and/or eyeball tracker.

The outward camera may be disposed toward the front of the user wearing the wearable device 101 (e.g., the direction where both eyes may face). The wearable device 101 may include a plurality of outward cameras. The embodiment is not limited thereto, and the outward camera may be disposed toward external space. By using the image and/or video acquired from the outward camera, the processor 410 may identify an external object. For example, the processor 410, based on the image and/or video acquired from the outward camera, may identify a position, a shape, and/or a gesture (e.g., a hand gesture) of the hand of the user wearing the wearable device 101. By using an image and/or a video regarding an external environment, acquired from an outward camera, the processor 410 may recognize or track one or more objects within the external environment.

In an embodiment, the motion sensor 422 may output an electrical signal indicating gravitational accelerations, accelerations, and/or angular velocities of a plurality of axes (e.g., x-axis, y-axis, and z-axis), which are perpendicular to one another and based on a designated origin within the wearable device 101 and/or the motion sensor 422. For example, the processor 410 may repeatedly receive or acquire sensor data from the motion sensor 422, based on a designated period (e.g., 1 millisecond), including accelerations, angular velocities, and/or magnitudes of magnetic fields corresponding to the number of the plurality of axes. In an embodiment, the motion sensor 422 may be referred to as an inertial measurement unit (IMU). The sensor 420 included in the wearable device 101 is not limited to those described above, and may include a grip sensor, a proximity sensor, a heartbeat sensor, a fingerprint sensor, an illuminance sensor, and/or a ToF sensor. By using the motion sensor 422, the processor 410 may detect a motion of the wearable device 101 (e.g., the motion of the wearable device 101 caused by a user wearing the wearable device 101).

In an embodiment, the communication circuit 430 of the wearable device 101 may include a hardware component for supporting transmission and/or reception of signals between the wearable device 101 and an external electronic device (e.g., the electronic device 102, the electronic device 104). The communication circuit 430 may include, for example, at least one of a modem, an antenna, or an optic/electronic (O/E) converter. The communication circuit 430 may support transmission and/or reception of electrical signals based on various types of protocols such as ethernet, local area network (LAN), wide area network (WAN), wireless fidelity (Wi-Fi), Bluetooth, Bluetooth low energy (BLE), Zigbee, long term evolution (LTE), and 5G new radio (5G NR).

In an embodiment, within the memory 415 of the wearable device 101, one or more instructions indicating data to be processed, calculations and/or operations to be performed by the processor 410 of the wearable device 101 may be stored. A set of the one or more instructions may be referred to as a program, firmware, operating system, process, routine, sub-routine, and/or software application (hereinafter, application). For example, the wearable device 101, and/or the processor 410, when a set of a plurality of instructions distributed in the form of an operating system, firmware, driver, program, and/or software application is executed, may perform at least one of the operations described below. Hereinafter, installing a software application in the wearable device 101 is storing one or more instructions in the form of the software application (or a package) in memory 415, and may refer to storing the one or more instructions in a format (e.g., a file with an extension designated by the operating system of the wearable device 101) that is executable by the processor 410. As an example, the application may include a program and/or a library related to a service provided to a user.

Referring to FIG. 4, the programs installed in the wearable device 101 may be included in any one of different layers including an application layer 440, a framework layer 450, and/or a hardware abstraction layer (HAL) 480, based on a target. For example, within the hardware abstraction layer 480, programs (e.g., modules or drivers) designed to target hardware (e.g., the display 250 and/or the sensor 420) of the wearable device 101 may be included. The framework layer 450, in terms of including one or more programs for providing an extended reality (XR) service, may be referred to as an XR framework layer. For example, the layers illustrated in FIG. 4 may be logically (or for the convenience of description) distinguished, and may not necessarily mean that an address space of the memory 415 is distinguished by the layers.

Within the framework layer 450, programs (e.g., a position tracker 471, a spatial recognizer 472, a gesture tracker 473, and/or a gaze tracker 474) designed to target at least one of the hardware abstraction layer 480 and/or the application layer 440 may be included. The programs included in the framework layer 450 may provide an application programming interface (API) executable (or invokable or callable) based on another program.

In the application layer 440, a program designed to target a user of the wearable device 101 may be included. As an example of programs included in the application layer 440, an extended reality (XR) system user interface (UI) 441, and/or an XR application 442 are illustrated, but the embodiment is not limited thereto. For example, the programs (e.g., software applications) included in the application layer 440 may cause execution of a function supported by programs included in the framework layer 450, by calling an API.

The wearable device 101, based on the execution of the XR system UI 441, may display one or more visual objects on the display 250 to perform interaction with a user. The visual object may refer to an object that may be disposed in a screen for transmission of information and/or interaction, such as text, image, icon, video, button, checkbox, radio button, text box, slider, and/or table. The visual object may be referred to as a visual guide, virtual object, visual element, UI element, view object, and/or view element. The wearable device 101, based on the execution of the XR system UI 441, may provide a user with functions available in a virtual space.

Referring to FIG. 4, a lightweight renderer 443, and/or an XR plugin 444 are illustrated to be included in the XR system UI 441, but it is not limited thereto. For example, based on the XR system UI 441, the processor 410 may execute the lightweight renderer 443, and/or the XR plugin 444 in the framework layer 450.

The wearable device 101, based on execution of the lightweight renderer 443, may acquire a resource (e.g., API, system process, and/or library) used to define, generate, and/or execute a rendering pipeline in which partial modification is allowed. The lightweight renderer 443, in terms of defining a rendering pipeline in which partial modification is allowed, may be referred to as a lightweight render pipeline. The lightweight renderer 443 may include a renderer (e.g., a prebuilt renderer) built before execution of a software application. For example, the wearable device 101, based on execution of the XR plugin 444, may acquire a resource (e.g., API, system process, and/or library) used to define, generate, and/or execute an entire rendering pipeline. The XR plugin 444, in terms of defining (or setting) the entire rendering pipeline, may be referred to as an open XR native client.

The wearable device 101, based on execution of the XR application 442, may display a screen representing at least a portion of the virtual space on the display 250. An XR plugin 441-1 included in the XR application 442 may include instructions that support functions similar to the XR plugin 444 of the XR system UI 441. In the description of the XR plugin 441-1, a description overlapping the description of the XR plugin 444 may be omitted. The wearable device 101, based on execution of the XR application 442, may cause execution of a virtual space manager 451.

The wearable device 101, based on execution of an application 445, may display an image in the virtual space on the display 250. The application 445 may be configured to output image information for displaying a two-dimensional image. The wearable device 101, based on execution of the application 445, may cause execution of the virtual space manager 451. The wearable device 101, based on execution of the application 445, may generate dual image information to represent the two-dimensional image in a three-dimensional virtual space. Here, the dual image information may include first image information for a left eye and second image information for a right eye, in consideration of binocular parallax. To represent the two-dimensional image in a three-dimensional virtual space, the wearable device 101 may generate the dual image information based on the image information for displaying the two-dimensional image.

According to an embodiment, the wearable device 101, based on execution of the virtual space manager 451, may provide a virtual space service. For example, the virtual space manager 451 may include a platform for supporting the virtual space service. The wearable device 101, based on execution of the virtual space manager 451, may identify a virtual space formed based on a user position represented by data acquired through the sensor 420, and may display at least a portion of the virtual space on the display 250. The virtual space manager 451 may be referred to as a composition presentation manager (CPM).

The virtual space manager 451 may include a runtime service 452. As an example, the runtime service 452 may be referred to as an OpenXR runtime module (or OpenXR runtime program). The wearable device 101, based on execution of the runtime service 452, may execute at least one of a user pose prediction function, a frame timing function, and/or a spatial input function. As an example, the wearable device 101, based on execution of the runtime service 452, may perform rendering for providing the virtual space service to a user. For example, based on execution of the runtime service 452, a function related to the virtual space, which is executable by the application layer 440, may be supported.

The virtual space manager 451 may include a pass-through manager 453. The wearable device 101, based on execution of the pass-through manager 453, may overlay and display, on at least a portion of a screen representing a virtual space on a display 250, an image and/or a video representing a real space acquired through an outward camera, during displaying the screen representing the virtual space.

The virtual space manager 451 may include an input manager 454. The wearable device 101, based on execution of the input manager 454, may identify data (e.g., sensor data) acquired by executing one or more programs included in a perception service layer 470. The wearable device 101 may identify a user input related to the wearable device 101, by using the acquired data. The user input may be related to a motion (e.g., hand gesture), gaze, and/or utterance of a user identified by the sensor 420 (e.g., the image sensor 421 such as the outward camera). The user input may be identified based on an external electronic device connected (or paired) through a communication circuit.

A perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstract layer 460 may be referred to as OpenPX. The perception abstract layer 460 may be used for a perception client and a perception service.

According to an embodiment, the perception service layer 470 may include one or more programs for processing data acquired from a sensor 420. The one or more programs may include at least one of the position tracker 471, the spatial recognizer 472, the gesture tracker 473, and/or the gaze tracker 474. The type and/or number of the one or more programs included in the perception service layer 470 are not limited to those illustrated in FIG. 4.

The wearable device 101, based on execution of the position tracker 471, may identify a pose of the wearable device 101 by using the sensor 420. The wearable device 101, based on execution of the position tracker 471, may identify a six degrees of freedom pose (6 dof pose) of the wearable device 101 by using data acquired through an outward camera (e.g., the image sensor 421) and/or an IMU (e.g., the motion sensor 422 including a gyroscope sensor, an acceleration sensor, and/or a geomagnetic sensor). The position tracker 471 may be referred to as a head tracking (HeT) module (or a head tracker, or a head tracking program).

The wearable device 101, based on execution of the spatial recognizer 472, may acquire information for providing a three-dimensional virtual space corresponding to a surrounding environment (e.g., external space) of the wearable device 101 (or a user of the wearable device 101). The wearable device 101, based on execution of the spatial recognizer 472, may reconstruct a surrounding environment of the wearable device 101 in three dimensions by using data acquired through an outward camera (e.g., the image sensor 421). The wearable device 101, based on execution of the spatial recognizer 472, may identify at least one of a plane, a slope, or stairs, based on the three-dimensionally reconstructed surrounding environment of the wearable device 101. The spatial recognizer 472 may be referred to as a scene understanding (SU) module (or a scene understanding program).

The wearable device 101, based on execution of the gesture tracker 473, may identify (or recognize) a pose and/or gesture of a hand of a user of the wearable device 101. As an example, the wearable device 101, based on execution of the gesture tracker 473, may identify a pose and/or gesture of a user's hand by using data acquired through an outward camera (e.g., the image sensor 421). As an example, the wearable device 101, based on execution of the gesture tracker 473, may identify a pose and/or gesture of a user's hand based on data (or an image) acquired through an outward camera. The gesture tracker 473 may be referred to as a hand tracking (HaT) module (or a hand tracking program), and/or a gesture tracking module.

The wearable device 101, based on execution of the gaze tracker 474, may identify (or track) a movement of eyes of a user of the wearable device 101. As an example, the wearable device 101, based on execution of the gaze tracker 474, may identify a movement of eyes of a user by using data acquired from a gaze tracking camera (e.g., the image sensor 421). The gaze tracker 474 may be referred to as an eye tracking (ET) module (or an eye tracking program), and/or a gaze tracking module.

The perception service layer 470 of the wearable device 101 may further include a face tracker 475 for tracking a face of a user. For example, the wearable device 101, based on execution of the face tracker 475, may identify (or track) a movement of a face and/or a facial expression of a user. The wearable device 101, based on execution of the face tracker 475, may estimate a user's facial expression based on a movement of a face of the user. As an example, the wearable device 101, based on execution of the face tracker 475, may identify a movement of a face and/or a facial expression of a user based on data (e.g., an image and/or a video) acquired by using a camera 425 (e.g., a camera facing at least a portion of a user's face).

Referring to FIG. 4, as an example of the processor 410, a CPU 411, a graphics processing unit (GPU) 412, and/or a display processing unit (DPU) 413 are illustrated. A renderer 490 may include instructions for rendering images in a three-dimensional virtual space. The processor 410 that executes the renderer 490 (e.g., the DPU 413) may acquire at least one image to be at least partially displayed in a displaying area of the display 250, from a software application (e.g., a software application executed by the CPU 411 and/or the GPU 412). For example, the processor 410 that executes the renderer 490 may determine a position of an area in which an application (e.g., the XR application 442, the application 445) is to be rendered. The processor 410 that executes the renderer 490 may generate an image of the application to be displayed on the display 250. The renderer 490 may generate a composite image to be displayed on the display 250, by compositing images.

The processor 410 that executes the renderer 490 may divide a displaying area of the display 250 into a foveated portion (which may be referred to as a foveated area) and a peripheral portion (which may be referred to as a remaining area) by using a gaze position calculated using the position tracker 471 and/or the gaze tracker 474. For example, the processor 410 that detects coordinate values of the gaze position may determine a portion of the displaying area that includes the coordinate values as the foveated area. The DPU 413 that executes the renderer 490 may acquire at least one image that corresponds to each of the foveated area and the remaining area, and has a size smaller than a size of the entire displaying area of the display 250, or a resolution lower than a resolution of the displaying area.

The processor 410 that executes the renderer 490 may acquire or generate a composite image to be displayed on the display 250, by compositing an image corresponding to the foveated area and an image corresponding to the peripheral portion. For example, the processor 410 may enlarge the image corresponding to the peripheral portion to a size of the entire displaying area of the display 250, by performing upscaling. On the enlarged image, the processor 410 may combine the image corresponding to the foveated area to generate a composite image to be displayed on the display 250. Along a boundary line of the image corresponding to the foveated area, the processor 410 may apply visual effects such as blur to blend the enlarged image and the image corresponding to the foveated area.

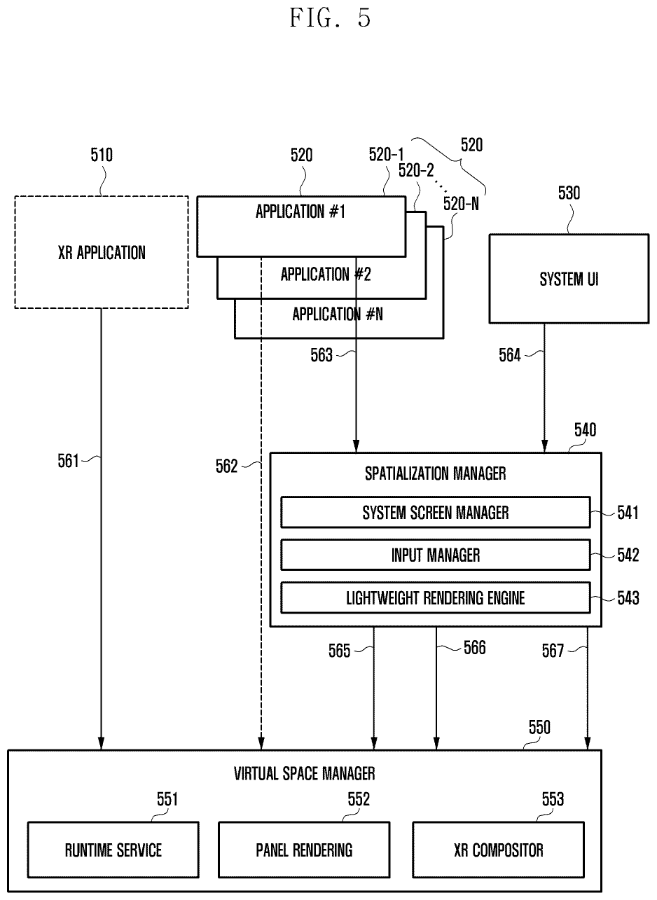

FIG. 5 illustrates an example of a block diagram of a wearable device (e.g., the electronic device 101 in FIG. 1) for displaying images in a virtual space according to an embodiment of the disclosure.

In FIG. 5, an example in which a plurality of programs/instructions for displaying images in a virtual space are executed is described. The plurality of programs/instructions may be all executed by a single processor (e.g., AP), or may be executed by a plurality of processors (e.g., an AP, a graphics processing unit (GPU), and a neural processing unit (NPU)). That the plurality of processors may execute the programs/instructions means that a part of the programs/instructions may be executed by a first processor, and another part of the programs/instructions may be executed by a second processor different from the first processor.

Referring to FIG. 5, the wearable device 101 may execute a virtual space manager 550 (e.g., the virtual space manager 451 in FIG. 4, CPM) to render images in a virtual space. For the virtual space manager 550, the descriptions of the virtual space manager 451 in FIG. 4 may be at least partially referenced. The virtual space manager 550 may include a platform for supporting a virtual space service. The virtual space manager 550 may include a runtime service 551 (e.g., OpenXR Runtime), panel rendering 552 (e.g., two dimensional (2D) Panel Render), and an XR compositor 553. The wearable device 101, based on execution of the runtime service 551, may execute at least one of a user pose prediction function, a frame timing function, and/or a spatial input function. For the runtime service 551, the descriptions of the runtime service 452 in FIG. 4 may be at least partially referenced. The wearable device 101, based on execution of the panel rendering 552, may display at least one image (video) on a panel (e.g., a 2D panel) so as to implement a virtual space through a display. For example, the wearable device 101 may display a rendered image corresponding to red, green, and blue (RGB) information 566 for a panel from a spatialization manager 540, which will be described below, through a display (e.g., the display 250). The wearable device 101, based on execution of the XR compositor 553, may composite an image (hereinafter, a pass-through image) of a real area captured by a camera on the virtual space, and a virtual area image. For example, the wearable device 101, based on execution of the XR compositor 553, may generate a composite image by merging the pass-through image and the virtual area image. The wearable device 101 may transmit the generated composite image to a display buffer such that the composite image is displayed. The wearable device 101 may identify a virtual space through the virtual space manager 550, and may display at least a portion of the virtual space on the display 250. The virtual space manager 550 may be referred to as a CPM. The wearable device 101 may execute the virtual space manager 550 to render an image corresponding to at least a portion of the virtual space.

According to an embodiment, the wearable device 101 may execute the spatialization manager 540. The spatialization manager 540 may perform processing for displaying images in a three-dimensional virtual space. The wearable device 101, based on execution of the spatialization manager 540, may perform preprocessing such that images are rendered in the three-dimensional virtual space through the virtual space manager 550. For example, the wearable device 101, based on execution of the spatialization manager 540, may perform at least a part of the functions of the renderer 490 in FIG. 4. The wearable device 101, based on execution of the spatialization manager 540, may process image information provided by an application (e.g., an XR application 510, an application 520 providing a general 2D screen that is not XR, or an application providing a system UI 530). The spatialization manager 540 (e.g., Space Flinger) may include a system screen manager 541 (e.g., System Scene), an input manager 542 (e.g., Input Routing), and a lightweight rendering engine 543 (e.g., Impress Engine). The system screen manager 541 may be executed to display the system UI 530. From a program (e.g., an API) that provides the system UI 530, system UI-related information 564 may be transmitted to the system screen manager 541. The system UI-related information 564 may be acquired through a spatializer API and/or a same-process private API. The spatialization manager 540 may determine a layout (e.g., position, display order) of a screen of the system UI 530 in a three-dimensional space through pre-assigned resources. The system screen manager 541 may transmit image information 567 for rendering the screen of the system UI 530, according to the layout, to the virtual space manager 550. The input manager 542 may be configured to process a user input (e.g., a user input on the system screen or application screen). The lightweight rendering engine 543 may be a renderer (e.g., the lightweight renderer 443) for generating images. For example, the lightweight rendering engine 543 may be used to display the system UI 530. According to an embodiment, the spatialization manager 540 may include the lightweight rendering engine 543 for rendering the system UI. According to an embodiment, when resources of the lightweight rendering engine 543 are insufficient for rendering an avatar used in an HMD, at least one external rendering engine may be used. In this case, to solve compatibility issues with the external rendering (e.g., a 3rd party engine), an external rendering engine support module may be added inside the spatialization manager 540.

According to an embodiment, the electronic device may execute an application. For example, in response to execution of the XR application 510 (e.g., the XR application 442, a three dimensional (3D) game, an XR map, or other immersive applications), the virtual space manager 550 may be executed. The wearable device 101 may provide dual image information 561 provided from the XR application 510 to the virtual space manager 550. To display an image in a three-dimensional space, the dual image information 561 may include two image information considering binocular parallax. For example, the dual image information 561 may include first image information for a left eye of a user and second image information for a right eye of the user, to render in the three-dimensional virtual space. Hereinafter, in the disclosure, the term dual image information is used as a term referring to image information for representing images for both eyes in a three-dimensional space. In addition to the dual image information, binocular image information, dual image data, dual image, binocular image data, stereo image information, 3D image information, spatial image information, spatial image data, 2D-3D conversion data, dimension conversion image data, binocular parallax image data, and/or technical terms equivalent thereto may be used. The wearable device 101 may generate a composite image by merging image layers through the virtual space manager 550. The wearable device 101 may transmit the generated composite image to a display buffer. The composite image may be displayed on the display 250 of the wearable device 101.

According to an embodiment, the electronic device may execute at least one application of the XR application 510 or other applications 520 (e.g., a first application 520-1, a second application 520-2, ..., an N-th application 520-N). According to an embodiment, the application 520 may be configured to output image information for displaying a two-dimensional image. In other words, the application 520 may provide a two-dimensional image. As an example, the application 520 may be an image application, a schedule application, or an internet browser application. It is assumed that, in response to execution of the application 520, image information 562 provided from the application 520 is provided to the virtual space manager 550. Since the image information 562 has only x coordinates and y coordinates on a two-dimensional plane, it may be difficult to consider precedent relationships (i.e., distance spaced apart from the user) among other applications centered on the user. The wearable device 101, when displaying the application 520 that provides a general 2D screen, may execute the spatialization manager 540 to provide dual image information to the virtual space manager 550. For example, based on execution of the spatialization manager 540, the wearable device 101 may receive application-related information 563 from the first application 520-1. For example, the application-related information 563 may include image information representing a two-dimensional image of the first application 520-1 (e.g., information including per-pixel RGB), and/or content information in the first application 520-1 (e.g., characteristics of content executed in the first application, type of the content). The application-related information 563 may be acquired through a spatializer API. Based on execution of the spatialization manager 540, the wearable device 101 may identify information on a position of an area to be rendered and a size of the area to be rendered by the first application 520-1 (hereinafter, position information). Based on execution of the spatialization manager 540, the wearable device 101 may generate dual image information 565 (e.g., RGBx2) considering binocular parallax of the user, through the image information and the position information. Based on execution of the spatialization manager 540, the wearable device 101 may provide the dual image information 565 to the virtual space manager 550. By converting a simple two-dimensional image into dual image information 565, problems caused by the image information 562 being directly delivered to the virtual space manager 550 may be resolved. In addition, as at least a part of functions for displaying an image in a virtual space are performed by the spatialization manager 540 instead of the virtual space manager 550, a burden of the virtual space manager 550 may be reduced. However, since the image information from the application 520 is not directly delivered to the virtual space manager 550, but is delivered through the spatialization manager 540, a quality of the image finally output to the user may be degraded. As an example, in the first application 520-1, an image is rendered at a resolution of approximately 2756×1846, but the image may be downsampled during delivery to the virtual space manager 550 through the spatialization manager 540 (e.g., down-sampled from a resolution of approximately 2756×1846 to a resolution of approximately 1160×680). Thereafter, the virtual space manager 550 may upsample a downsampled image (e.g., from a resolution of approximately 1160×680 to a resolution of approximately 1625×1070), and may deliver the upsampled image to the display buffer. As such, in the process in which an image is delivered from the application 520 to the spatialization manager 540, and from the spatialization manager 540 to the virtual space manager 550, problems such as resolution mismatch, aliasing in the upsampling process, or image quality degradation may occur. To resolve the above-described problems, in the disclosure, based on the system structure illustrated in FIG. 5, technologies for controlling a resolution of an area to be displayed from an application, and for performing foveation rendering, are described.

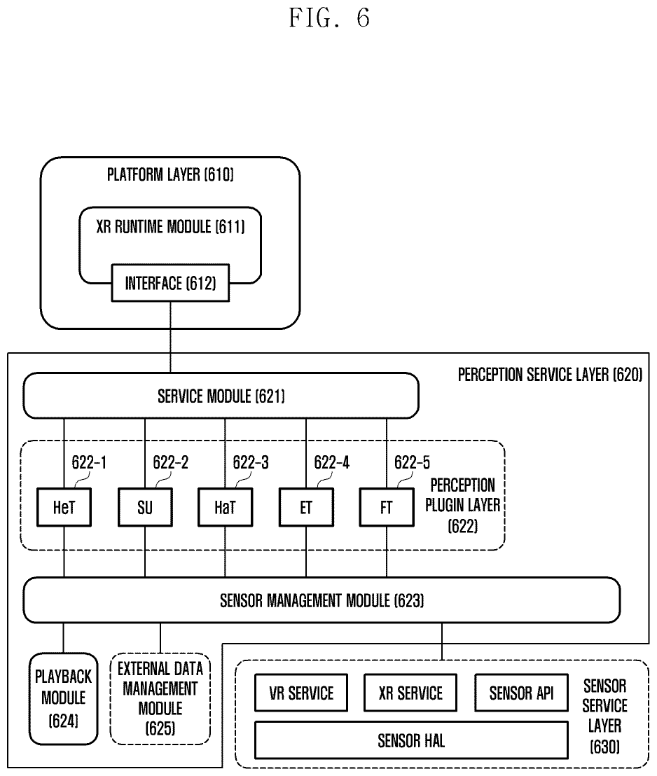

FIG. 6 illustrates an example of a structure of a plurality of layers according to an embodiment of the disclosure.

Referring to FIG. 6, programs installed in the wearable device 101 may be classified into one of a platform layer 610, a perception service layer 620 (e.g., the perception service layer 470 in FIG. 4), or a sensor service layer 630. For example, the wearable device 101 may operate based on the platform layer 610, the perception service layer 620, and the sensor service layer 630.

According to an embodiment, the platform layer 610 may be configured for an XR service. For example, the platform layer 610 may include a platform (e.g., an Android platform) for supporting the XR service. For example, the platform layer 610 may include the virtual space manager 550 in FIG. 5. The platform layer 610 may include a runtime module 611. For the runtime module 611, the descriptions of the runtime service 551 in FIG. 5 and the runtime service 452 in FIG. 4 may be referenced. As an example, the runtime module 611 may be referred to as an OpenXR runtime module. The XR runtime module 611 may be used to provide at least one of a user pose prediction function, a frame timing function, and/or a spatial input function through the wearable device 101. As an example, the XR runtime module 611 may be used to perform rendering for providing the XR service to a user. For example, based on the runtime module 611, an application (e.g., a Unity or OpenXR native application) may be implemented.

A interface 612 may be used for data exchange between the platform layer 610 and the perception service layer 620. For the interface 612, the descriptions of the perception abstract layer 460 in FIG. 4 may be referenced. As an example, the interface 612 may be referred to as OpenPX. The interface 612 may be used for a perception client and a perception service.

According to an embodiment, the perception service layer 620 may include a service module 621, a perception plugin layer 622, a sensor management module 623, a playback module 624, and/or an external data management module 625. For example, the perception service layer 620 may include at least one of the service module 621, the perception plugin layer 622, the sensor management module 623, the playback module 624, and/or the external data management module 625. For example, at least a part of the service module 621, the perception plugin layer 622, the sensor management module 623, the playback module 624, or the external data management module 625 may be omitted.

The service module 621 may manage input data of the wearable device 101. The service module 621 may be used to manage data (e.g., gesture information) acquired from a plurality of perception modules included in the perception plugin layer 622. As an example, the service module 621 may be referred to as SxrDataService.

The service module 621 may perform interfacing with an upper layer (e.g., the platform layer 610 or the runtime module 611). The service module 621 may exchange data with an upper layer (e.g., the platform layer 610 or the runtime module 611) through the interface 612. As an example, the interface 612 may be referred to as OpenPX. According to an embodiment, the service module 621 may support not only OpenPX, but also an OpenXR Extension. The service module 621 may be used to exchange data (e.g., gesture information) among a plurality of perception modules. The service module 621 may be configured to manage data processed in the perception service layer 620. The service module 621 may select, among the data, data to be perceived as an input of the wearable device 101. The data may include data acquired from the plurality of perception modules and data acquired through the external data management module 625. The service module 621 may manage data to be used in the interface 612. The service module 621 may select, among the data, data to be perceived as an input of the wearable device 101, and may provide the selected data to the interface 612.

The perception plugin layer 622 may include a plurality of perception modules. The plurality of perception modules may be referred to as a plurality of perception solutions.

As an example, the plurality of perception modules may include at least one among a head tracking (HeT) module 622-1, a scene understanding (SU) module 622-2, a hand tracking (HaT) module 622-3, an eye tracking (ET) module 622-4, or a face tracking (FT) module 622-5. Each of the plurality of perception modules included in the perception plugin layer 622 may include a common interface for connection (or interworking) with the sensor management module 623. Each of the plurality of perception modules may include a common interface for connection (or interworking) with the sensor management module 623.

The head tracking module 622-1 may identify a pose of the wearable device 101 by using at least one sensor of the wearable device 101. As an example, the head tracking module 622-1 may identify a six degrees of freedom pose (6 dof pose) of the wearable device 101, based on data acquired by using a camera (e.g., the image sensor 421 in FIG. 4) and an IMU.

The scene understanding module 622-2 may be used to construct a surrounding environment of the wearable device 101 (or a user of the wearable device 101) as a three-dimensional virtual space. The scene understanding module 622-2 may be used to reconstruct a surrounding environment of the wearable device 101 in three dimensions, based on data acquired by using a camera (e.g., the image sensor 421 in FIG. 4). The scene understanding module 622-2, based on the surrounding environment of the wearable device 101 reconstructed in three dimensions, may identify at least one of a plane, an incline, or stairs.

The hand tracking module 622-3 may be used to identify (or recognize) a pose and/or a gesture of a hand of a user of the wearable device 101. As an example, the hand tracking module 622-3 may identify a pose and/or a gesture of a hand of the user, based on data acquired from at least one sensor. As an example, the hand tracking module 622-3 may identify a pose and/or a gesture of the user's hand, based on data (e.g., an image) acquired by using a camera.

The eye tracking module 622-4 may be used to identify (or track) a movement of an eye of a user of the wearable device 101. As an example, the eye tracking module 622-4 may identify a movement of the user's eye, based on data acquired from at least one sensor. As an example, the eye tracking module 622-4 may identify a movement of the user's eye, based on data acquired by using a camera (e.g., the gaze tracking camera 260-1 in FIGS. 2B and 3A) and/or an infrared light emitting diode (IR LED).

The face tracking module 622-5 may be used to identify (or track) a movement of a face of a user and/or a facial expression of the user. The face tracking module 622-5, based on the movement of the user's face, may estimate a facial expression of the user. As an example, the face tracking module 622-5 may identify a movement of the user's face and/or a facial expression of the user, based on data (e.g., an image) acquired by using a camera (e.g., the camera 260 in FIGS. 2A and 2B).

As an example, the plurality of perception modules included in the perception plugin layer 622 may be configured in a plugin structure. As an example, some of the plurality of perception modules may be replaced with other modules, independently of the sensor service layer 630 and the platform layer 610, which are lower layers of the perception service layer 620.

According to an embodiment, the sensor management module 623 may be used to provide (or transmit) data to each of the plurality of perception modules through a common interface. For example, the sensor management module 623 may be used to separate (or remove) a dependency between the sensor service layer 630, which is a lower layer, and the perception plugin layer 622, which is an upper layer. For example, the sensor management module 623 may be referred to as SxrSensorServiceManager.

The sensor management module 623 may support various modules (or sensor services) of the sensor service layer 630. The plurality of perception modules may not directly interface with the sensor service layer 630. The plurality of perception modules may receive data (e.g., sensor data) through the sensor management module 623. Therefore, even when a module of the sensor service layer 630 is changed, it may not affect the plurality of perception modules.

The sensor management module 623 may further include a load balancing module. The load balancing module may identify data provided from the sensor service layer 630. The load balancing module, based on the data provided from the sensor service layer 630, may identify at least some of the plurality of perception modules. The load balancing module may provide data to at least some of the identified perception modules. As an example, the load balancing module may distribute data to the plurality of perception modules, based on the states of the plurality of perception modules and/or the state of the wearable device 101. As an example, the load balancing module may filter data to be provided to the plurality of perception modules, based on the states of the plurality of perception modules and/or the state of the wearable device 101. According to an embodiment, the load balancing module may be configured independently of the sensor management module 623. The load balancing module may be referred to as SxrPerceptionLoadBalancer.

The playback module 624 may be used to provide a stored dataset in real-time to at least one of the plurality of perception modules through playback. As an example, the dataset may be stored through the playback module 624, based on a designated specification. The dataset may include not only first data acquired from the sensor service layer 630 but also second data acquired based on the first data acquired from the sensor service layer 630 (e.g., virtual object data or synthetic data). As an example, the first data may be referred to as sensor data. The second data may be referred to as virtual data.

According to an embodiment, the wearable device 101 may receive data from an external electronic device. For example, the data received from the external electronic device may include first data acquired from a service layer included in the external electronic device and/or second data acquired based on the first data. The wearable device 101 may perform playback (or a playback function) by using the data received from the external electronic device. The wearable device 101 may transmit a result of performing the playback (or playback function) to the external electronic device. For example, the wearable device 101 may be used to process data acquired from an external electronic device instead. The wearable device 101 may receive data acquired from at least one sensor of the external electronic device. The wearable device 101, based on the received data, may acquire information (e.g., information on six degrees of freedom pose) acquired through the playback module 624 (or the plurality of perception modules). The wearable device 101 may transmit the acquired information to the external electronic device. The external electronic device may provide an XR service based on the acquired information.

The playback module 624 may perform playback (or a playback function) based on at least one of the first data or the second data. According to an embodiment, the playback module 624 may perform playback by combining (or mixing) real-time data (e.g., runtime data) and pre-stored data.

As an example, the playback may mean a function of using stored data (or gesture information) according to the operation of the wearable device 101. As an example, the playback may mean a function of identifying a value regarding the performance of the XR service through comparison between gesture information acquired based on a designated operation regarding the XR service and reference gesture information according to the designated operation.

As an example, the playback may mean a function of acquiring performance information of the XR service provided to the user of the wearable device 101. The playback module 624 may identify information on a user who has performed a designated operation (e.g., mission) regarding the XR service (e.g., gesture information). The playback module 624 may identify reference information on the designated operation. The reference information may mean information for determining completion of performance of the designated operation. The playback module 624 may identify similarity between the information on the user who has performed the designated operation and the reference information. The playback module 624, based on the similarity, may identify whether performing the designated operation has been completed by the user.

According to an embodiment, the playback module 624 may be included in the sensor management module 623. For example, the playback module 624 may perform playback through the sensor management module 623 without changing the plurality of perception modules.

The external data management module 625 may be used to manage data acquired through an external electronic device (e.g., smart watch, smartphone, or tablet personal computer (PC)) connected to the wearable device 101 (or at least one sensor of the external electronic device). As an example, the external data management module 625 may improve accuracy of the plurality of perception modules by using the data acquired from the external electronic device. As an example, the external data management module 625, by using the data acquired from the external electronic device, may calibrate the data (or gesture information) acquired from the plurality of perception modules. According to an embodiment, the external data management module 625 may not be included in the perception service layer 620.

The sensor service layer 630 may be used to control at least one sensor (e.g., camera, IMU, or time of flight (TOF) sensor). For example, the sensor service layer 630 may be used to provide a service for accessing at least one sensor. For example, the sensor service layer 630 may include at least one of a module for VR service (e.g., QVRservice), a module for XR service (e.g., SxrSensorService), a sensor API (e.g., android sensor API), or a sensor hardware abstraction layer (sensor HAL).

According to an embodiment, the sensor management module 623 may provide sensor data to the perception plugin layer 622 through a common interface. For example, the sensor management module 623 may provide sensor data to each of the plurality of perception modules through the same interface. For example, the sensor management module 623, based on modifying (or changing) configuration information (e.g., a configuration file) regarding the sensor management module 623, may provide sensor data according to an operation of the perception module to the perception module without changing the configuration information of the perception plugin layer 622.

The sensor management module 623, based on an operation of at least one of the plurality of perception modules, may identify sensor data for the at least one perception module. The sensor management module 623 may provide the identified sensor data to the at least one perception module.

According to an embodiment, when the head tracking module 622-1 is driven, the sensor management module 623 may acquire camera data and IMU data through at least one of a module for VR service, a module for XR service, a sensor API, or a sensor hardware abstraction layer in the sensor service layer 630. The sensor management module 623 may provide the camera data and the IMU data to the head tracking module 622-1. According to an embodiment, the camera data and the IMU data may be acquired through different modules.

According to an embodiment, when the scene understanding module 622-2 is driven in playback mode, the sensor management module 623 may identify stored camera data and stored pose data. The sensor management module 623 may provide the camera data and the pose data to the scene understanding module 622-2.

According to an embodiment, the service module 621 may be configured to remove dependency on an upper layer of the perception plugin layer 622. For example, the upper layer of the perception plugin layer 622 may include a platform layer 610 (e.g., android XR) and/or an application layer (e.g., the application layer 440 in FIG. 4).

The service module 621 may manage input data of the wearable device 101. The service module 621 may be configured to manage, in an integrated manner, information (e.g., gesture information or tracking data) acquired from the plurality of perception modules. The service module 621 may provide converted information to the upper layer after converting the information (e.g., gesture information or tracking data) according to a requirement of the upper layer without changing the plurality of perception modules.

As an example, the service module 621 may acquire information on six degrees of freedom pose from the head tracking module 622-1. The information on the six degrees of freedom pose acquired from the head tracking module 622-1 may be configured in a quaternion format. On the other hand, an upper layer (e.g., the platform layer 610) may request information on the six degrees of freedom pose configured in an axis-angle representation format. The service module 621 may change (or convert) the information on the six degrees of freedom pose configured in a quaternion format into information on the six degrees of freedom pose configured in an axis-angle representation format. The service module 621 may provide the information on the six degrees of freedom pose configured in an axis-angle representation format to the upper layer (e.g., the platform layer 610). However, the disclosure is not limited thereto. For example, the service module 621 may change (or convert) the information on the six degrees of freedom pose configured in an axis-angle representation format into information on the six degrees of freedom pose configured in a quaternion format, and may provide it to the upper layer.

As an example, the service module 621 may acquire information on hand movement from the hand tracking module 622-3. The information on the hand movement may be acquired based on movements of a first number of joints. On the other hand, an upper layer (e.g., the platform layer 610) may request information on the hand movement acquired based on movements of a second number of joints. The service module 621 may perform one of a joint interpolation procedure or a simplification procedure. The service module 621, based on performing one of a joint interpolation procedure or a simplification procedure, may support a structure of joints required by the upper layer.

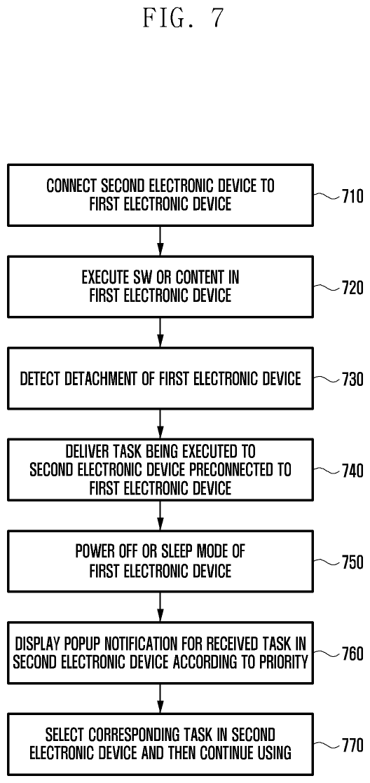

FIG. 7 is a flowchart illustrating a method for driving the wearable device 101 according to an embodiment of the disclosure.

The operations illustrated in FIG. 7 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 7.

At least some of the operations illustrated in FIG. 7 may be omitted. Before or after at least some of the operations illustrated in FIG. 7, at least some of the operations mentioned with reference to other drawings in the disclosure may be additionally inserted.

According to an embodiment, at least some of the operations illustrated in FIG. 7 may be performed sequentially. According to an embodiment, at least some of the operations illustrated in FIG. 7 may be performed in parallel (simultaneously). According to an embodiment, at least some of the operations illustrated in FIG. 7 may be performed with the order thereof changed.

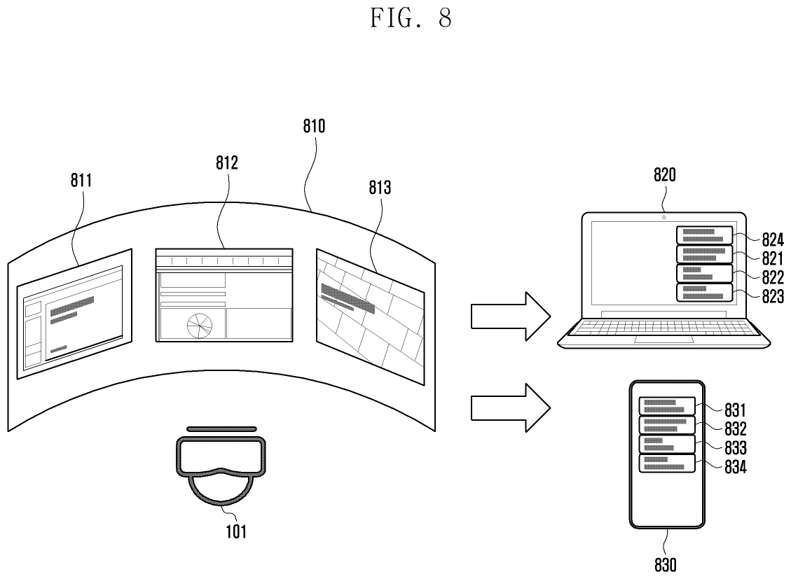

Referring to FIG. 7, a method for driving the wearable device 101 according to an embodiment will be described. In FIG. 7, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 7, an external electronic device may be referred to as a second electronic device (e.g., the second electronic device 820 in FIG. 8). The second electronic device 820 may be a mobile phone, a tablet PC, a desktop PC, a laptop device, or a TV.

In operation 710, the second electronic device 820 may be communicatively connected to the first electronic device 101 according to an embodiment. According to an embodiment, the first electronic device 101 and the second electronic device 820 may be devices registered with a server based on a user account. For example, the first electronic device 101 and the second electronic device 820 may be devices registered with the server under the same user account. According to an embodiment, the first electronic device 101 and the second electronic device 820 may deliver data (e.g., task and/or command) to each other through the server. According to an embodiment, the first electronic device 101 and the second electronic device 820 may directly communicate with each other through short-range communication. For example, the first electronic device 101 may directly deliver data (e.g., task and/or command) to the second electronic device 820 using short-range communication such as Bluetooth or Wi-Fi.

In operation 720, software or content may be executed in the first electronic device 101 according to an embodiment. According to an embodiment, the first electronic device 101 may execute one or more applications, software, or content based on a user input. For example, the first electronic device 101 may execute an application related to document work, an application related to editing of sound sources or images, or an application for playing back content, based on the user input.

In operation 730, it may be detected that the first electronic device 101 according to an embodiment has been detached from the user. According to an embodiment, the first electronic device 101 may detect that the user detaches the first electronic device 101 by using at least one sensor.

In operation 740, the first electronic device 101 according to an embodiment may deliver a task being executed to the second electronic device 820 that is preconnected thereto. According to an embodiment, when detecting detachment, the first electronic device 101 may deliver a task related to an application being executed or content being executed, and a command related to the task, to the second electronic device 820. According to an embodiment, the first electronic device 101 may deliver the task and the command to the second electronic device 820 through the server. According to an embodiment, the first electronic device 101 may directly communicate with the second electronic device 820, and may deliver the task and the command to the second electronic device 820 through the direct communication. According to an embodiment, when there is no second electronic device 820 preconnected to the first electronic device 101, the first electronic device 101 may deliver the task and the command to another electronic device that has a prior connection history or that is connectable. For example, when there is no second electronic device 820 that is preconnected to the first electronic device 101, the first electronic device 101 may perform a connection with a connectable second electronic device 820. According to an embodiment, the first electronic device 101 may use a cloud or an account viewing position synchronization service as a method for delivering a task and a command to the second electronic device 820.

According to an embodiment, the task information transmitted by the first electronic device 101 may include information of an application being executed, software files, or settings and data for computation, such as simulation.

In operation 750, the first electronic device 101 according to an embodiment may turn off power or change to a sleep mode. According to an embodiment, when the delivery of the task and the command to the second electronic device 820 is completed, the first electronic device 101 may turn off power or enter the sleep mode. According to an embodiment, the sleep mode may refer to a low power mode, and, for example, may indicate a state in which the performance and power consumption of the components included in the first electronic device 101 are lower compared to a normal mode.

In operation 760, the second electronic device 820 according to an embodiment may display the received task in the form of a popup notification, according to a preset priority. According to an embodiment, the second electronic device 820 may display the task received from the first electronic device 101 in the form of a popup notification according to the priority. For example, the second electronic device 820 may receive n tasks from the first electronic device 101, and may sort a popup list of the n tasks according to the priority. According to an embodiment, the priority for the second electronic device 820 to display the task may vary based on the order received from the first electronic device 101, the frequency of use in the second electronic device 820, the most recently saved or executed order in the first electronic device 101, or whether a program related to the task is installed in the second electronic device 820. According to an embodiment, in case that the software for executing a received task is not installed in the second electronic device 820 when the task is received from the first electronic device 101, the second electronic device 820 may provide a download link, or may download and install the software from a server. According to an embodiment, when the software is not installed, the second electronic device 820 may directly receive the software from the first electronic device 101, and may display a popup screen for that purpose.

In operation 770, the second electronic device 820 according to an embodiment may allow the software or content to be continuously used after selecting the corresponding task. According to an embodiment, based on a user input selecting the task, the second electronic device 820 may continuously execute the task that was being executed in the first electronic device 101. According to an embodiment, the second electronic device 820 may display a screen corresponding to a result of executing the task. Accordingly, a user may continuously use the software or content that was being used through the first electronic device 101, after detaching the first electronic device 101, through the second electronic device 820.

FIG. 8 is a conceptual diagram illustrating a method for driving the wearable device 101 according to an embodiment of the disclosure.

Referring to FIG. 8, the reference numeral 810 denotes a mixed reality space 810, including augmented reality or virtual reality provided by the wearable device 101. According to an embodiment, the wearable device 101 may display an execution screen of at least one application in the mixed reality space 810. For example, the wearable device 101 may display an execution screen 811 of a first application, an execution screen 812 of a second application, and an execution screen 813 of a third application in the mixed reality space 810, but the disclosure is not limited thereto.

In FIG. 8, the wearable device 101 may be referred to as the “first electronic device 101.”

According to an embodiment, as the illustrated example, the wearable device 101 may display the execution screen 811 of the first application, the execution screen 812 of the second application, and the execution screen 813 of the third application in the mixed reality space 810, based on a user input. According to an embodiment, as described in operation 730 and operation 740 of FIG. 7, the wearable device 101 may detect that a user detaches the wearable device 101 while displaying the execution screen 811 of the first application, the execution screen 812 of the second application, and the execution screen 813 of the third application.

According to an embodiment, the wearable device 101, in response to detecting the detachment, may deliver a task to at least one of the external electronic devices 820 and 830. For example, the wearable device 101 may deliver tasks and commands related to the first application, the second application, and the third application to the second electronic device 820 and the third electronic device 830.

According to an embodiment, the second electronic device 820 and the third electronic device 830 may receive the task from the wearable device 101 and may display the received task in a popup notification form. For example, the second electronic device 820 may display a first popup notification 821 related to the first application, a second popup notification 822 related to the second application, a third popup notification 823 related to the third application, and a popup notification 824 related to the detachment detection of the wearable device 101. For example, the third electronic device 830 may display a first popup notification 831 related to the first application, a second popup notification 832 related to the second application, a third popup notification 833 related to the third application, and a popup notification 834 related to the detachment detection of the wearable device 101.

In the illustrated example, the second electronic device 820 is a laptop device, and the third electronic device 830 is a mobile phone, but the disclosure is not limited thereto. Each of the second electronic device 820 and the third electronic device 830 may be a mobile phone, a tablet PC, a desktop PC, a laptop device, or a TV.

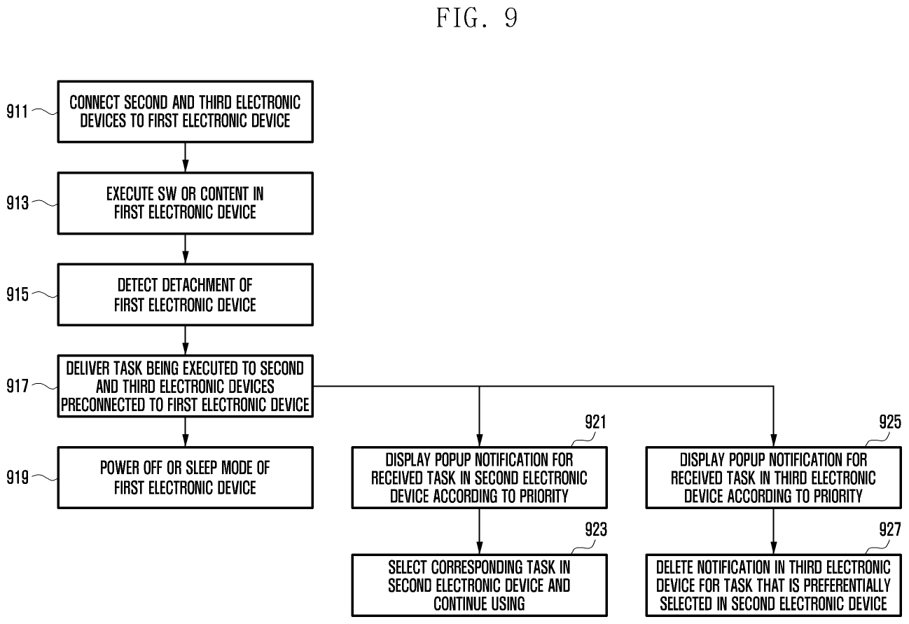

FIG. 9 is a flowchart illustrating a method in which the wearable device 101 delivers a task according to an embodiment of the disclosure.

The operations illustrated in FIG. 9 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 9.

At least some of the operations illustrated in FIG. 9 may be omitted. Before or after at least some of the operations illustrated in FIG. 9, at least some of the operations mentioned with reference to other drawings in the disclosure may be additionally inserted.

According to an embodiment, at least some of the operations illustrated in FIG. 9 may be performed sequentially. According to an embodiment, at least some of the operations illustrated in FIG. 9 may be performed in parallel (simultaneously). According to an embodiment, at least some of the operations illustrated in FIG. 9 may be performed with the order thereof changed.

Referring to FIG. 9, a method for delivering a task by the wearable device 101 according to an embodiment will be described. In FIG. 9, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 9, the external electronic device may be referred to as the second electronic device (e.g., the second electronic device 820 in FIG. 8) and/or the third electronic device (e.g., the third electronic device 830 in FIG. 8). Each of the second electronic device 820 and the third electronic device 830 may be a mobile phone, a tablet PC, a desktop PC, a laptop device, or a TV.

In operation 911, the second electronic device 820 and the third electronic device 830 may be communicatively connected to the first electronic device 101 according to an embodiment. The first electronic device 101, the second electronic device 820, and/or the third electronic device 830 may be devices registered to a server based on a user account. For example, the first electronic device 101, the second electronic device 820, and/or the third electronic device 830 may be devices registered to a server with the same user account. According to an embodiment, the first electronic device 101 and/or the third electronic device 830 may deliver data (e.g., task and/or command) to each other through a server. According to an embodiment, the first electronic device 101 and/or the third electronic device 830 may directly communicate with each other via short-range communication. For example, the first electronic device 101 may directly deliver data (e.g., task and/or command) to the third electronic device 830 using short-range communication such as Bluetooth. Operation 911 may be at least partially similar to operation 710 described with reference to FIG. 7.

In operation 913, software or content may be executed in the first electronic device 101 according to an embodiment. Operation 913 may be at least partially similar to operation 720 described with reference to FIG. 7. According to an embodiment, the first electronic device 101, as the example illustrated in FIG. 8, may display the execution screen 811 of the first application, the execution screen 812 of the second application, and the execution screen 813 of the third application in the mixed reality space 810, based on a user input.

In operation 915, it may be detected that the first electronic device 101 according to an embodiment has been detached from the user. Operation 915 may be at least partially similar to operation 730 described with reference to FIG. 7.

In operation 917, the first electronic device 101 according to an embodiment may deliver a task being executed to the second electronic device 820 and the third electronic device 830 that are preconnected thereto. Operation 917 may be at least partially similar to operation 740 described with reference to FIG. 7. According to an embodiment, the first electronic device 101, in response to detecting the user's detachment, may deliver a task to at least one of the external electronic devices 820 and 830. For example, the first electronic device 101 may deliver tasks and commands related to the first application, the second application, and the third application to the second electronic device 820 and the third electronic device 830.

In operation 919, the first electronic device 101 according to an embodiment may turn off power or change to a sleep mode (or a low power mode). Operation 919 may be at least partially similar to operation 750 described with reference to FIG. 7.

In operation 921, the second electronic device 820 according to an embodiment may display the received task in the form of a popup notification, according to a preset priority. Operation 921 may be at least partially similar to operation 760 described with reference to FIG. 7. For example, as the example illustrated in FIG. 8, the second electronic device 820 may display a first popup notification related to the first application, a second popup notification related to the second application, a third popup notification related to a third application, and a popup notification related to the detachment detection of the first electronic device 101.

In operation 923, the second electronic device 820 according to an embodiment may allow the software or content to be continuously used after selecting the corresponding task. For example, the second electronic device 820 may select a task to be continuously executed based on a user input. Operation 923 may be at least partially similar to operation 770 described with reference to FIG. 7.

In operation 925, the third electronic device 830 according to an embodiment may display the received task in the form of a popup notification, according to a preset priority. Operation 925 may be at least partially similar to operation 740 described with reference to FIG. 7. For example, as the example illustrated in FIG. 8, the third electronic device 830 may display a first popup notification related to the first application, a second popup notification related to a second application, a third popup notification related to a third application, and a popup notification related to the detachment detection of the first electronic device 101.

In operation 927, in the third electronic device 830 according to an embodiment, a task selected by the second electronic device 820 may be deleted from a popup notification. According to an embodiment, a list of tasks received by the second electronic device 820 from the first electronic device 101 may be the same as a list of tasks received by the third electronic device 830 from the first electronic device 101. According to an embodiment, when the second electronic device 820 selects a specific task based on a user input, the third electronic device 830 may delete the selected task from a popup list displayed in the third electronic device 830. For example, when a user selects a task related to the second application through the second electronic device 820, the third electronic device 830 may receive information related to the user's selection through the first electronic device 101, the second electronic device 820, or a server, and based on the received information, may delete the popup notification related to the second application from a popup notification list.

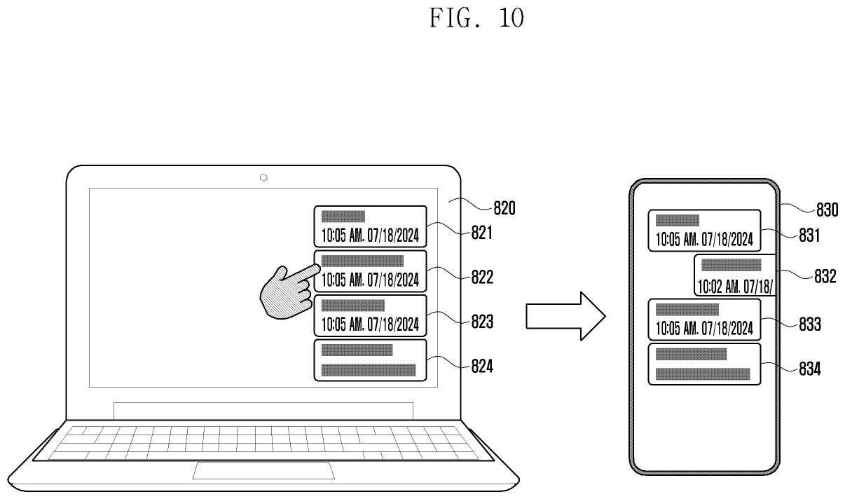

FIG. 10 is a diagram illustrating a case in which an external electronic device displays a popup notification according to an embodiment of the disclosure.

For example, FIG. 10 illustrates the second electronic device 820 and the third electronic device 830 as external electronic devices. The second electronic device 820 and the third electronic device 830 illustrated in FIG. 10 may be substantially the same as the second electronic device 820 and the third electronic device 830 described with reference to FIG. 8.

Referring to FIG. 10, the second electronic device 820 and the third electronic device 830 according to an embodiment may display a list of tasks received from the first electronic device 101 (e.g., the wearable device 101) according to operation 917, operation 921, and operation 925 described with reference to FIG. 9.

According to an embodiment, the second electronic device 820 may display a first popup notification 821 related to a first application, a second popup notification 822 related to a second application, a third popup notification 823 related to a third application, and a popup notification 824 related to a detachment detection of the wearable device 101.

According to an embodiment, the third electronic device 830 may display a first popup notification 831 related to the first application, a second popup notification 832 related to the second application, a third popup notification 833 related to the third application, and a popup notification 834 related to the detachment detection of the wearable device 101.

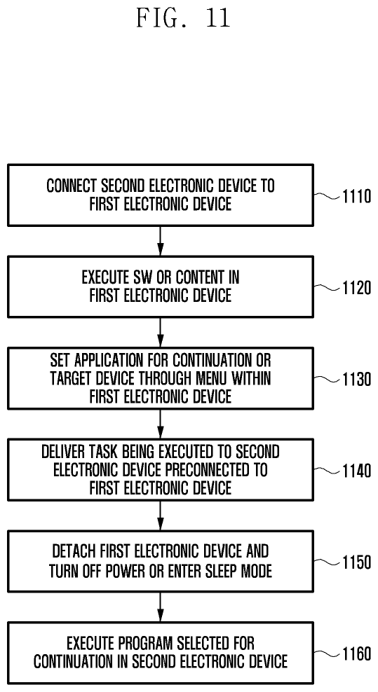

FIG. 11 is a flowchart illustrating a method in which the wearable device 101 delivers a task according to an embodiment of the disclosure.

The operations illustrated in FIG. 11 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 11.

At least some of the operations illustrated in FIG. 11 may be omitted. Before or after at least some of the operations illustrated in FIG. 11, at least some of the operations mentioned with reference to other drawings in the disclosure may be additionally inserted.

According to an embodiment, at least some of the operations illustrated in FIG. 11 may be performed sequentially. According to an embodiment, at least some of the operations illustrated in FIG. 11 may be performed in parallel (simultaneously). According to an embodiment, at least some of the operations illustrated in FIG. 11 may be performed with the order thereof changed.

Referring to FIG. 11, a method for delivering a task by the wearable device 101 according to an embodiment will be described. In FIG. 11, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 11, the external electronic device may be referred to as the second electronic device 820. The second electronic device 820 may be a mobile phone, a tablet PC, a desktop PC, a laptop device, or a TV.

In operation 1110, the second electronic device 820 may be communicatively connected to the first electronic device 101 according to an embodiment. Operation 1110 may be at least partially similar to operation 710 described with reference to FIG. 7.

In operation 1120, software or content may be executed in the first electronic device 101 according to an embodiment. Operation 1120 may be at least partially similar to operation 720 described with reference to FIG. 7.

In operation 1130, the first electronic device 101 according to an embodiment may set program continuation (or application continuation) or a target device through a menu within the first electronic device 101. According to an embodiment, when delivering a task to the second electronic device 820, the first electronic device 101 may receive an input for selecting the task to be delivered directly by a user. According to an embodiment, when delivering a task to the second electronic device 820, the first electronic device 101 may determine a task to be delivered based on detecting a user gesture or a user's gaze. According to an embodiment, when determining a task to be delivered to the second electronic device 820, the first electronic device 101 may provide a continuation icon or a move button within the mixed reality space 810. According to an embodiment, when receiving a user input selecting the continuation icon or the move button, the first electronic device 101 may deliver the corresponding task to the second electronic device 820. According to an embodiment, the first electronic device 101 may deliver the task to the second electronic device 820 based on a user input selecting the second electronic device 820 displayed within the mixed reality space 810 in a see-through mode. According to an embodiment, the first electronic device 101 may select a task through eye tracking, and deliver the selected task to the second electronic device 820. According to an embodiment, the first electronic device 101 may set the target device directly through program-and application-specific icons, or set the target device through environment settings. According to an embodiment, the first electronic device 101, based on a preset for the continuation icon, may automatically deliver the task to the second electronic device 820 when detecting that a user detaches the first electronic device 101.

In operation 1140, the first electronic device 101 according to an embodiment may deliver a task being executed to the second electronic device 820 that is preconnected thereto. Operation 1140 may be at least partially similar to operation 740 described with reference to FIG. 7.

In operation 1150, the first electronic device 101 according to an embodiment may detect that the device is detached from the user, and may turn off power or change to sleep mode. Operation 1150 may be at least partially similar to operation 750 described with reference to FIG. 7.

In operation 1160, the second electronic device 820 according to an embodiment may continuously execute the previously selected program. Operation 1160 may be at least partially similar to operation 770 described with reference to FIG. 7.

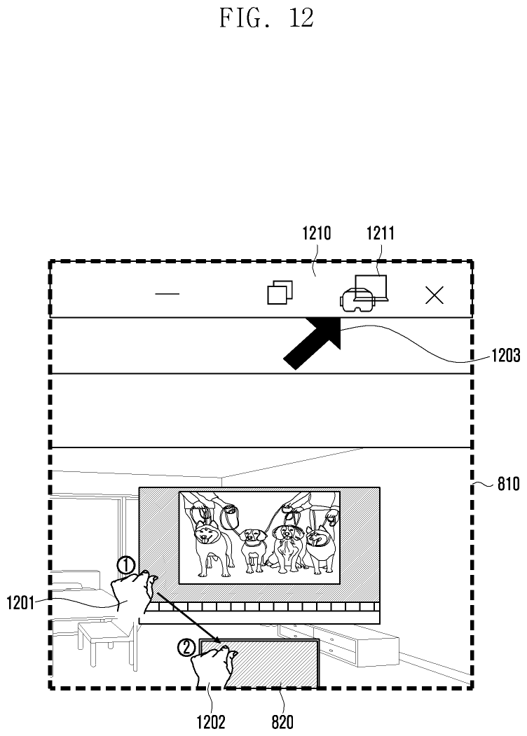

FIG. 12 is a diagram illustrating a case in which the wearable device 101 receives a user input according to an embodiment of the disclosure.

In FIG. 12, the wearable device 101 may be referred to as the “first electronic device 101.”

Referring to FIG. 12, the wearable device 101 according to an embodiment may display the mixed reality space 810 including augmented reality or virtual reality. According to an embodiment, the wearable device 101 may execute one or more applications, software, or content in the mixed reality space 810. For example, the wearable device 101 may execute an application related to document work, an application related to editing of sound sources or images, or an application for playing back content, based on the user input.

According to an embodiment, as described with reference to operation 1130 in FIG. 11, the wearable device 101 may set a continuation application or a target device through a menu. According to an embodiment, when delivering a task to the second electronic device 820, the wearable device 101 may receive an input for selecting the task to be delivered directly by a user. According to an embodiment, when delivering a task to the second electronic device 820, the wearable device 101 may determine a task to be delivered based on detecting a user gesture or a user's gaze. For example, the wearable device 101 may detect a user gesture in which a portion of the execution screen 1210 of the application in the mixed reality space 810 is used as a starting point 1201, and the second electronic device 820 displayed in the mixed reality space 810 in see-through mode is used as an end point 1202. According to an embodiment, the wearable device 101 may deliver the task to the second electronic device 820 in response to the detected user gesture.

According to an embodiment, when determining the task to be delivered to the second electronic device 820, the wearable device 101 may provide a continuation icon 1211 or a move button in the mixed reality space 810. For example, the wearable device 101 may display the continuation icon 1211 or move button in a portion of the execution screen of the application. According to an embodiment, when receiving a user input 1203 selecting the continuation icon or move button, the wearable device 101 may deliver the corresponding task to the second electronic device 820. According to an embodiment, when there are a plurality of external electronic devices communicatively connected to the wearable device 101, the wearable device 101 may display a plurality of continuation icons 1211 or move buttons.

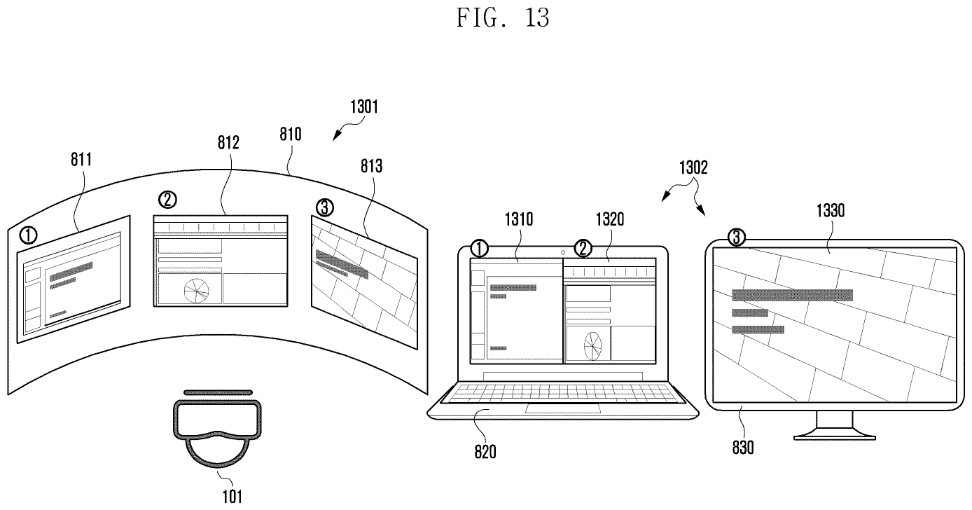

FIG. 13 is a diagram illustrating a layout in which an external electronic device displays a received task according to an embodiment of the disclosure.

In FIGS. 13, 1301 indicates a state in which the wearable device 101 displays the mixed reality space 810. In FIGS. 13, 1302 indicates a state in which at least one external electronic device 820 or 830, for example, the second electronic device 820 and the third electronic device 830, executes the task received from the wearable device 101 and displays the execution screen. In FIG. 13, the wearable device 101 may be referred to as the “first electronic device 101.”

Referring to FIG. 13, in state 1301, the wearable device 101 may display the mixed reality space 810, and may execute one or more applications, software, or content within the mixed reality space 810. For example, the wearable device 101 may execute an application related to document work, an application related to editing of sound sources or images, or an application for playing back content, based on the user input.

According to an embodiment, the wearable device 101 may display the execution screen 811 of the first application, the execution screen 812 of the second application, and the execution screen 813 of the third application in the mixed reality space 810, based on a user input. According to an embodiment, as described in operation 730 and operation 740 of FIG. 7, the wearable device 101 may detect that a user detaches the wearable device 101 while displaying the execution screen 811 of the first application, the execution screen 812 of the second application, and the execution screen 813 of the third application. According to an embodiment, when the wearable device 101 detects the detachment, the wearable device 101 may deliver tasks related to the first application, second application, and third application to the second electronic device 820 and the third electronic device 830.

According to an embodiment, in delivering the tasks to the second electronic device 820 and the third electronic device 830, the wearable device 101 may cause the arrangement of the execution screens displayed in the mixed reality space 810 by the wearable device 101 to become similar in the second electronic device 820 and the third electronic device 830. For example, in state 1301, the wearable device 101 may arrange, in order from the left, the execution screen 811 of the first application, the execution screen 812 of the second application, and the execution screen 813 of the third application. According to an embodiment, in delivering the tasks to the second electronic device 820 and the third electronic device 830, the wearable device 101 may deliver tasks and commands such that the second electronic device 820 and the third electronic device 830 arrange, in order from the left, an execution screen 1310 of the first application, an execution screen 1320 of the second application, and an execution screen 1330 of the third application.

According to an embodiment, the wearable device 101 may identify the relative disposition of the second electronic device 820 and the third electronic device 830, as viewed in the mixed reality space 810 in see-through mode. For example, the wearable device 101 may identify that the second electronic device 820 is positioned to the left of the third electronic device 830, as viewed in the mixed reality space 810 in see-through mode. According to an embodiment, based on identifying that the second electronic device 820 is positioned to the left of the third electronic device 830, as viewed in the mixed reality space 810, the wearable device 101 may transmit tasks and commands such that the second electronic device 820 displays, from the left, the execution screen 1310 of the first application and the execution screen 1320 of the second application, and the third electronic device 830 disposed to the right of the second electronic device 820 displays the execution screen 1330 of the third application.

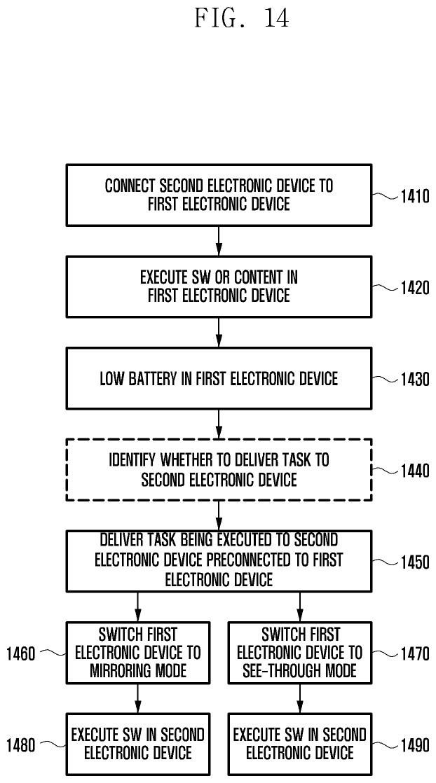

FIG. 14 is a flowchart illustrating an operation of the wearable device when the wearable device 101 is in a low battery state according to an embodiment of the disclosure.

The operations illustrated in FIG. 14 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 14. In FIG. 14, the wearable device 101 may be referred to as the “first electronic device 101.”

At least some of the operations illustrated in FIG. 14 may be omitted. Before or after at least some of the operations illustrated in FIG. 14, at least some of the operations mentioned with reference to other drawings in the disclosure may be additionally inserted.

According to an embodiment, at least some of the operations illustrated in FIG. 14 may be performed sequentially. According to an embodiment, at least some of the operations illustrated in FIG. 14 may be performed in parallel (simultaneously). According to an embodiment, at least some of the operations illustrated in FIG. 14 may be performed with the order thereof changed.

Referring to FIG. 14, an operation of the wearable device 101 according to an embodiment when the wearable device 101 is not easy to deliver a task to an external electronic device will be described. In FIG. 14, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 14, the external electronic device may be referred to as the second electronic device 820. The second electronic device 820 may be a mobile phone, a tablet PC, a desktop PC, a laptop device, or a TV.

In operation 1410, the second electronic device 820 may be communicatively connected to the first electronic device 101 according to an embodiment. Operation 1410 may be at least partially similar to operation 710 described with reference to FIG. 7.

In operation 1420, software or content may be executed in the first electronic device 101 according to an embodiment. Operation 1410 may be at least partially similar to operation 720 described with reference to FIG. 7.

In operation 1430, it may be detected that the first electronic device 101 according to an embodiment is in a low battery state. According to an embodiment, the low battery state may be a state in which the battery level (or SOC) of a battery included in the first electronic device 101 is less than a designated threshold value. According to an embodiment, the first electronic device 101 may consider it difficult to continue performing a task when the first electronic device 101 is in a low battery state, and may suggest to the user that the task be delivered to the second electronic device 820. According to an embodiment, in determining whether the first electronic device 101 is in the low battery state, the first electronic device 101 may consider factors such as expected usage time according to the application being executed, the current battery level (or SOC), or the temperature of the device.

In operation 1440, the first electronic device 101 according to an embodiment may identify whether to deliver the task to the second electronic device 820. According to an embodiment, the first electronic device 101 may display a notification of the low battery state, and may receive confirmation from the user whether to deliver the task to the second electronic device 820. Operation 1440 may be at least partially similar to operation 1130 described with reference to FIG. 11.

In operation 1450, the first electronic device 101 according to an embodiment may deliver a task being executed to the second electronic device 820 that is preconnected thereto. Operation 1450 may be at least partially similar to operation 740 described with reference to FIG. 7.

In operation 1460, the first electronic device 101 according to an embodiment may switch to a mirroring mode. According to an embodiment, in the mirroring mode, the first electronic device 101 may receive a screen displayed by the second electronic device 820, and may display the received screen.

In operation 1470, the first electronic device 101 according to an embodiment may switch to a see-through mode. According to an embodiment, in the see-through mode, the first electronic device 101 may display a see-through image including a reality space. According to an embodiment, in the see-through mode, the first electronic device 101 may display, as a see-through image, a screen of a task executed by the second electronic device 820 that is disposed in reality space, the task having been delivered from the first electronic device 101.

In operation 1480, the second electronic device 820 according to an embodiment may continuously execute the application program. Operation 1480 may be at least partially similar to operation 770 described with reference to FIG. 7. According to an embodiment, when the second electronic device 820 generates a screen by executing a task, the first electronic device 101 may receive a screen displayed by the second electronic device 820 in a mirroring mode, and may display the received screen.

In operation 1490, the second electronic device 820 according to an embodiment may continuously execute the application program. Operation 1490 may be at least partially similar to operation 770 described with reference to FIG. 7. According to an embodiment, when the second electronic device 820 generates a screen by executing a task, the first electronic device 101 may display, as a see-through image, a screen of a task executed by the second electronic device 820 that is disposed in reality space in a see-through mode, the task having been delivered from the first electronic device 101.

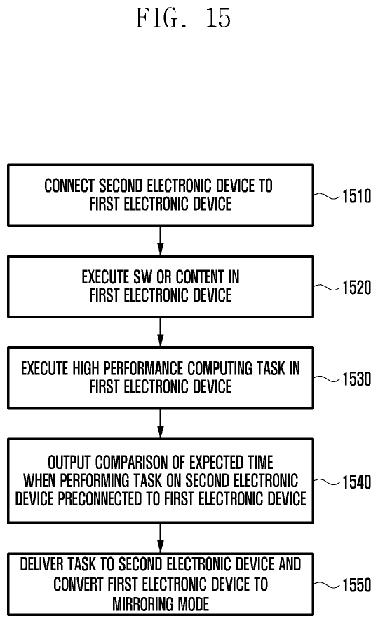

FIG. 15 is a flowchart illustrating an operation of the wearable device when the wearable device 101 executes a task requiring high performance according to an embodiment of the disclosure.

The operations illustrated in FIG. 15 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 15. At least some of the operations illustrated in FIG. 15 may be omitted. Before or after at least some of the operations illustrated in FIG. 15, at least some of the operations mentioned with reference to other drawings in the disclosure may be additionally inserted.

According to an embodiment, at least some of the operations illustrated in FIG. 15 may be performed sequentially. According to an embodiment, at least some of the operations illustrated in FIG. 15 may be performed in parallel (simultaneously). According to an embodiment, at least some of the operations illustrated in FIG. 15 may be performed with the order thereof changed.

Referring to FIG. 15, an operation of the wearable device 101 when the wearable device 101 according to an embodiment executes a task requiring high performance will be described. In FIG. 15, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 15, the external electronic device may be referred to as the second electronic device 820. The second electronic device 820 may be a mobile phone, a tablet PC, a desktop PC, a laptop device, or a TV.

In operation 1510, the second electronic device 820 may be communicatively connected to the first electronic device 101 according to an embodiment. Operation 1510 may be at least partially similar to operation 710 described with reference to FIG. 7.

In operation 1520, software or content may be executed in the first electronic device 101 according to an embodiment. Operation 1520 may be at least partially similar to operation 720 described with reference to FIG. 7.

In operation 1530, a first electronic device 101 according to an embodiment may execute a task requiring high-performance computing. According to an embodiment, the task requiring high-performance computing may refer to a task that requires a large amount of computation exceeding a designated threshold and is expected to take more than a designated amount of time to complete processing.

In operation 1540, a first electronic device 101 according to an embodiment may output a comparison of the expected time in a case of performing the task requiring high-performance computing on a second electronic device 820 that is previously connected. According to an embodiment, when performing a task including a high-performance computing task based on a user input, the first electronic device 101 may calculate an expected time in case of performing the corresponding task on an external electronic device. For example, the second electronic device 820, which is an external electronic device may be a high-performance desktop PC or a server. According to an embodiment, when performing a high-performance computing task, the first electronic device 101 may display a switching guide to the second electronic device 820, for example, an expected simulation completion time upon switching. According to an embodiment, the first electronic device 101 may store in advance capability-related information of the second electronic device 820, including hardware specifications, remaining battery level, or wireless LAN speed. According to an embodiment, the first electronic device 101 may calculate an expected execution time when the second electronic device 820 performs the high-performance computing task based on the pre-stored capability information of the second electronic device 820.

In operation 1550, the first electronic device 101 according to an embodiment may deliver the task to the second electronic device 820 and may convert to a mirroring mode. According to an embodiment, even after delivering the task to the second electronic device 820, the first electronic device 101 may continue to execute the corresponding software including the high-performance computing task. According to an embodiment, when the second electronic device completes the high-performance computing task, the first electronic device 101 may receive the completed result data from the second electronic device 820, and may update the task and screen of the software based on the received result data.

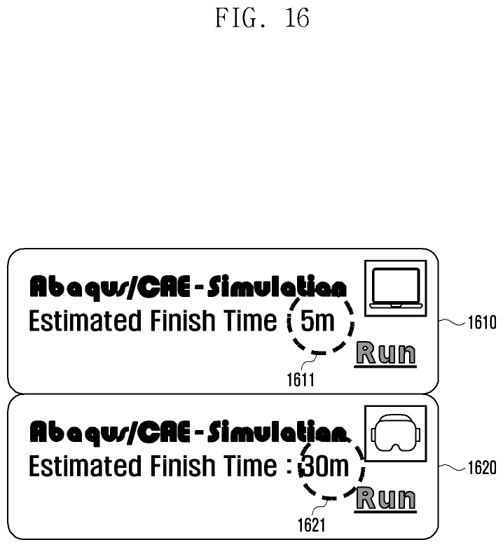

FIG. 16 is a diagram illustrating a notification indicating an expected execution time of a task requiring high performance according to an embodiment of the disclosure.

In FIG. 16, the wearable device 101 may be referred to as the “first electronic device 101.”

Referring to FIG. 16, as described in operation 1540 of FIG. 15, the wearable device 101 according to an embodiment may output a comparison of the expected time when the high-performance computing task is performed on the second electronic device 820 that is preconnected to the wearable device 101. For example, the wearable device 101 may display together a first notification 1610 indicating a case where the second electronic device 820 performs the high-performance computing task instead, and a second notification 1620 indicating a case where the wearable device 101 directly performs the high-performance computing task. According to an embodiment, the wearable device 101 may include and provide a first expected time 1611 in the first notification 1610, when the second electronic device 820 performs the task instead. According to an embodiment, the wearable device 101 may include and provide a second expected time 1621 in the second notification 1620, when the wearable device 101 directly performs the high-performance computing task.

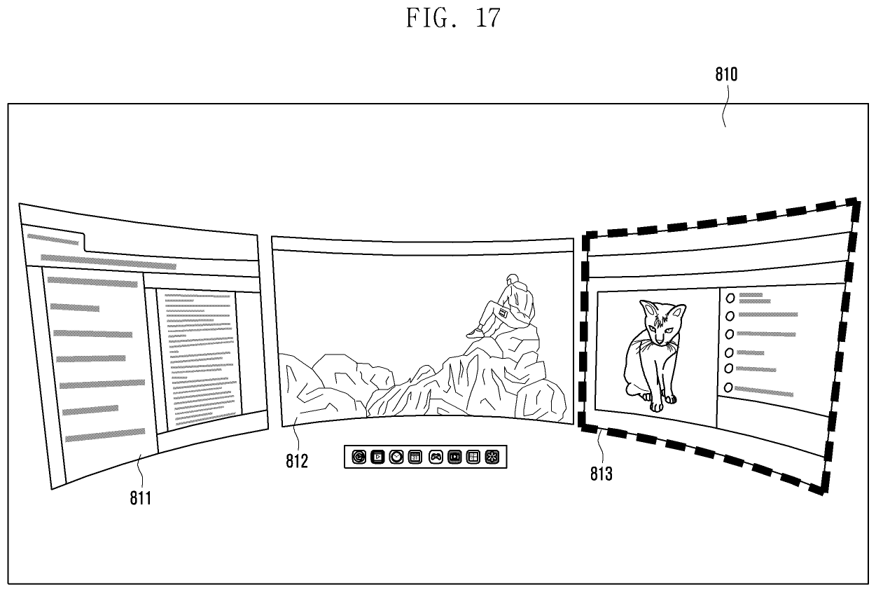

FIG. 17 illustrates an example of a mixed reality space 810 including augmented reality or virtual reality provided by the wearable device 101 according to an embodiment of the disclosure.

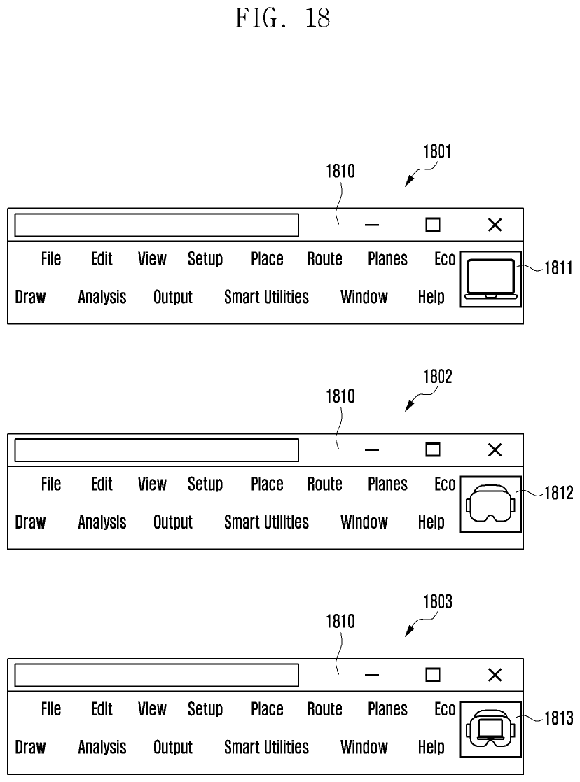

FIG. 18 is a diagram illustrating a notification indicating an execution state of a task according to an embodiment of the disclosure.

The wearable device 101 in FIGS. 17 and 18 may be referred to as the “first electronic device 101.”

In FIG. 17, the reference numeral 810 denotes a mixed reality space 810, including augmented reality or virtual reality provided by the wearable device 101. According to an embodiment, the wearable device 101 may display an execution screen of at least one application in the mixed reality space 810. For example, the wearable device 101 may display an execution screen 811 of a first application, an execution screen 812 of a second application, and an execution screen 813 of a third application in the mixed reality space 810, but the disclosure is not limited thereto.

Referring to FIG. 17, the wearable device 101 according to an embodiment may display a notification indicating an execution state of a task. For example, the wearable device 101 may apply a designated effect to an outline of a window representing a screen of an application when a task of the application is performed in an on-device form, or when the screen of the application performed in the second electronic device 820 is displayed in a mirroring form, or when at least a portion of the task of the application is processed instead in the second external device. For example, in the example illustrated in FIG. 17, it is shown that the wearable device 101 applies an effect in the form of a dotted line to the outline of the window representing the execution screen 813 of the third application. According to an embodiment, the effect applied to the outline of the window may include a color of various colors, a dotted line, or brightness.

Referring to FIG. 18, the wearable device 101 may display a notification indicating an execution state of a task in the form of an icon. For example, as in state 1801 in FIG. 18, when a screen of an application performed in the second electronic device 820 is displayed in a mirroring form, the wearable device 101 may display a first icon 1811 on at least a portion of the execution screen or the window 1810. For example, as in state 1802 in FIG. 18, when a task of the application is performed in an on-device form, the wearable device 101 may display a second icon 1812 on at least a portion of the execution screen or the window 1810. For example, as in state 1803 in FIG. 18, when at least a portion of the task of the application is processed instead in a second external device, the wearable device 101 may display a third icon 1813 on at least a portion of the execution screen or the window 1810.

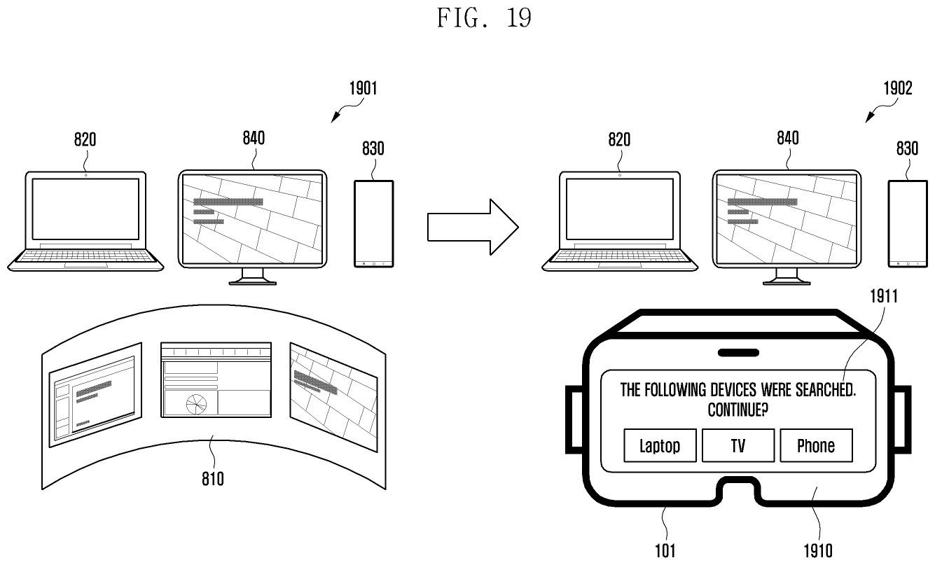

FIG. 19 is a diagram illustrating an operation of the wearable device 101 when detachment of the wearable device 101 by a user is detected according to an embodiment of the disclosure.

In FIG. 19, state 1901 may indicate a state in which the wearable device 101 performs a task and is connected to at least one external electronic device 820, 830, or 840. In FIG. 19, state 1902 may indicate a state in which, based on detecting the detachment of the wearable device 101 by the user, a connection to at least one of the external electronic devices 820, 830, or 840 is suggested through the external display 1910. In FIG. 19, the wearable device 101 may be referred to as the “first electronic device 101.”

Referring to FIG. 19, when the wearable device 101 according to an embodiment detects that a user detaches the wearable device 101, the wearable device 101 may deliver at least a portion of a task of an application that was being executed to at least one external electronic device 820, 830, or 840. According to an embodiment, the at least one external electronic device 820, 830, or 840 may be a device registered on a server with the same user account as the wearable device 101 and may be the closest neighboring device connected to the network. According to an embodiment, the at least one external electronic device 820, 830, or 840 may be a device that first detects an input (e.g., touch, or mouse click) from a user among devices disposed around the wearable device 101. According to an embodiment, the wearable device 101 may receive a user input from an input device connected to the wearable device 101, when selecting a device in which the application will continue to be executed. For example, the wearable device 101 may execute a document editing application, and the document editing application may provide a function of a user editing a document while a keyboard is connected to the wearable device 101. In this case, the wearable device 101 may select another device to which the keyboard is connected, in selecting the device in which the application will continue to be executed.

According to an embodiment, as illustrated in FIG. 19, the wearable device 101 may include an external display 1910. In this case, when the wearable device 101 detects detachment by the user, the wearable device 101 may display a popup 1911 through the external display 1910 to ask the user whether to continue executing the application executed in the wearable device 101 on the searched external electronic device 820, 830, or 840. According to an embodiment, the wearable device 101 may display a menu through the external display 1910, allowing selection of not only the device to be continuously executed but also the application to be continuously executed.

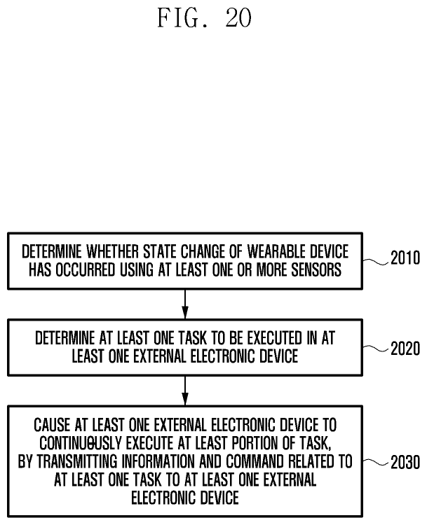

FIG. 20 is a flowchart illustrating a method for driving the wearable device 101 according to an embodiment of the disclosure.

The operations illustrated in FIG. 20 may be performed by instructions stored in memory (e.g., the memory 130 in FIG. 1). For example, when the instructions are executed by a processor (e.g., the processor 120 in FIG. 1), the instructions may cause the wearable device 101 (e.g., the electronic device 101 in FIG. 1) to perform the operations illustrated in FIG. 20.

At least some of the operations illustrated in FIG. 20 may be omitted. Before or after at least some of the operations illustrated in FIG. 20, at least some of the operations mentioned with reference to other drawings in the disclosure may be additionally inserted.

According to an embodiment, at least some of the operations illustrated in FIG. 20 may be performed sequentially. According to an embodiment, at least some of the operations illustrated in FIG. 20 may be performed in parallel (simultaneously). According to an embodiment, at least some of the operations illustrated in FIG. 20 may be performed with the order thereof changed.

Referring to FIG. 20, a method for driving the wearable device 101 according to an embodiment will be described. In FIG. 20, the wearable device 101 may be referred to as a first electronic device 101, and may be a head-mount device (HMD), a headgear electronic device, a glasses-type electronic device, a video see-through or visible see-through (VST) device, an extended reality (XR) device, a virtual reality (VR) device, and/or an augmented reality (AR) device. In FIG. 20, the external electronic device may be a mobile phone, a tablet PC, a desktop PC, a laptop device, or a TV.

In operation 2010, the wearable device 101 according to an embodiment may determine whether there is a state change of the wearable device 101 has occurred using at least one sensor. Operation 2010 may be at least partially similar to operation 1430 described with reference to FIG. 14.

According to an embodiment, the operation of determining whether there is a state change of the wearable device 101 has occurred may include an operation of identifying battery level-related information or information detected from at least one sensor. According to an embodiment, the battery level-related information may include low battery information or power saving mode setting-related information. According to an embodiment, the low battery information may be determined based at least in part on the expected usage time according to the application being executed and the current remaining battery level. According to an embodiment, the information detected from at least one sensor may include wear detection information of the wearable device 101. For example, the wear detection information may be determined based on the information acquired through an eye tracking camera, a strap fastening sensor, or a proximity sensor. According to an embodiment, the information detected from at least one sensor may include information related to the user's eye fatigue or dizziness. For example, the information related to eye fatigue or dizziness may be information determined using artificial intelligence based on the information acquired through the eye tracking camera.

In operation 2020, the wearable device 101 according to an embodiment may determine at least one task to be executed in at least one of the external electronic devices 820 or 830. Operation 2020 may be at least partially similar to operation 1130 described with reference to FIG. 11.

According to an embodiment, the task may be a task of an application that has been at least partially executed in the wearable device 101, or a task of an application that is being executed.

According to an embodiment, the external electronic device may configure and display a selection menu by using at least a portion of the information related to at least one application being executed in the wearable device 101 and the information related to at least one external electronic device 820 or 830. For example, the external electronic device may determine the task to be continuously performed based on the user input for the selection menu.

According to an embodiment, the wearable device 101 may include an external display 1910, and when the detachment of the wearable device 101 by the user is detected, the wearable device 101 may display a popup through the external display 1910 to ask the user whether to continue executing the application executed in the wearable device 101 in the searched external electronic device. According to an embodiment, the wearable device 101 may display the information displayed through the external display 1910 for a designated time, for example, for a first time. According to an embodiment, the wearable device 101 may operate in a first low power mode for a first time, and may operate in a second low power mode after the first time has elapsed. According to an embodiment, the second low power mode may be a mode having lower power consumption than the first low power mode. According to an embodiment, the user input for the selection menu may include at least one of an air gesture input, a touch input, or a voice input.

According to an embodiment, the external electronic device may be another electronic device registered with the same account (e.g., a first user account) as the wearable device 101. According to an embodiment, the external electronic device may be a mobile phone, a tablet PC, a desktop PC, a laptop device, or a TV.

According to an embodiment, the external electronic device may be determined through an operation of grouping, via a user input, one external electronic device present in the actual environment displayed on a display, and at least one application-related image displayed by being generated on the display.

According to an embodiment, the user input may be an input including at least one of an air gesture input, a gaze input, or a voice input. According to an embodiment, the air gesture may include a drag and drop operation. According to an embodiment, the air gesture may be an input received from an auxiliary input device.

According to an embodiment, the external electronic device may be determined through an operation in which the wearable device 101 collects attribute information of at least one of the external electronic devices 820 or 830, and groups at least one application and at least one of the external electronic device 820 or 830 using the attribute information of the external electronic device and information of at least one application. According to an embodiment, the attribute information of the external electronic device may be acquired from an external account management server. According to an embodiment, the attribute information of the external electronic device may be acquired through a local network from each external electronic device. For example, the local network may include BLE, BT, or Wi-Fi. According to an embodiment, the attribute information of the external electronic device may include at least a part of application information installed in the external electronic device, information related to available input means of the external electronic device, information related to power of the external electronic device, or current operation state information of the external electronic device. According to an embodiment, the grouping operation may be performed using an AI function.

According to an embodiment, the external electronic device may be an electronic device connectable with the wearable device 101.

According to an embodiment, the external electronic device may be an electronic device registered with the same account (e.g., a first user account) or a shared account as the wearable device 101.

According to an embodiment, the external electronic device may be an electronic device connected to the same network (AP) as the wearable device 101.

According to an embodiment, the external electronic device may be an electronic device capable of receiving peer-to-peer (P2P) service signals with the wearable device 101. For example, the P2P-based service may be a BLE-based service or a ultra-wideband (UWB)-based service.

In operation 2030, the wearable device 101 according to an embodiment may cause at least one of the external electronic devices 820 or 830 to execute at least a portion of the task subsequently, by transmitting at least one task-related information and command to at least one of the external electronic devices 820 or 830. Operation 2030 may be at least partially similar to operation 770 described with reference to FIG. 7.

According to an embodiment, the operation of delivering task-related information to an external electronic device may be an operation directly performed through a direct communication connection (e.g., device-to-device (D2D) method) with the external electronic device.

According to an embodiment, the operation of delivering task-related information to an external electronic device may be an operation indirectly performed through a connection with an external server.

According to an embodiment, the task-related information may include current context-related information of the application. According to an embodiment, the context information may include at least a part of file information used by the task or screen display information of the corresponding application. According to an embodiment, the context information may include operation-related information of the task being performed by the task or operation-related information to be performed by the task. According to an embodiment, the operation-related information of the task may include computation information for performing the task operation. According to an embodiment, the computation for the task operation may include computations related to artificial intelligence.

According to an embodiment, the task may include a content generation application or a content consumption application. For example, the content generation application may include at least one of a document creating application, a video and image editing application, or computer-aided design (CAD). For example, the content consumption application may include at least one of a video player, a music player, an image viewer, or a text viewer.

According to various embodiments, the wearable device 101 of the disclosure may, when a user detaches the wearable device 101, in order to continue watching the video player that was being viewed in full screen on the current screen on the TV, display a UI/user experience (UX) that allows selection of playback by connecting the video player to a partial area of the currently turned-on TV screen.

According to various embodiments, the wearable device 101 of the disclosure, when a low battery or overheating situation is detected while performing a video editing task in a stand-alone form, may allow a part of its computation function to be performed by an external electronic device, such as a mobile terminal and/or a laptop, which is connectable.

According to various embodiments, the wearable device 101 of the disclosure, in an extreme low battery situation where the battery level is very low, before turning off the power of the wearable device 101, may display, on an internal display screen of the wearable device 101, a list of external electronic devices to which an application operating on the wearable device 101 is to be transferred for execution, and a list of applications that are executable after being transferred, so that a user may make a selection.

According to various embodiments, the wearable device 101 of the disclosure, when the wearable device 101 is detached, may display, on a screen of the external display 1910 of the wearable device 101, a list of external electronic devices to which applications operating on the wearable device 101 are to be transferred for execution, and a list of applications that are executable after being transferred, so that a user may make a selection.

According to various embodiments, the wearable device 101 of the disclosure, when the wearable device 101 is detached, may display, on a display screen of an external electronic device, a list of external electronic devices to which applications operating on the wearable device 101 are to be transferred for execution, and a list of applications that are executable after being transferred, so that a user may make a selection.

According to various embodiments, when a battery level falls to a designated level or lower, the wearable device 101 of the disclosure may collect information on external electronic devices and may perform a preparation operation in advance to perform a connected task when requested by the wearable device 101. For example, when a document application is executed in connection with a laptop, the document application may be executed in advance as the background of the laptop, or the wearable device 101 may automatically save the document application currently being worked on, thereby uploading the saved data to a server accessible by the laptop in advance.

According to various embodiments, the wearable device 101 of the disclosure may, when the wearable device 101 is detached, automatically assign an external electronic device capable of executing an application currently being executed, without a user selection, activate the assigned external electronic device, and allow the external electronic device to continue to execute the application being executed. In this case, the wearable device 101 may identify the compatibility of the external electronic device.

According to an embodiment, the wearable device 101 may identify in advance the positions of external electronic devices in a see-through mode, and may set an arrangement of screens to be continuously displayed by the external electronic devices based on the arrangement of execution screens of applications currently being displayed by the wearable device 101.

According to various embodiments, the wearable device 101 of the disclosure, when delivering an application being executed in the wearable device 101 to an external electronic device for execution, may determine, as a delivery target, an external electronic device to which an input device connected to the wearable device 101 is connected.

According to various embodiments, the wearable device 101 of the disclosure, when wireless mouse and wireless keyboard are connected to the wearable device 101 and internet browsing is being performed, may, upon detachment of the wearable device 101, deliver information related to the corresponding internet browsing to allow for the continuous use, when only the TV exists as the external electronic device nearby, and in this case, the wearable device 101 may switch the connection of the keyboard and mouse, which were connected to the external electronic device, to the TV.

According to various embodiments, the wearable device 101 of the disclosure may allow the user, in a see-through environment of the wearable device 101, to select and/or move an application currently being executed in the wearable device 101 via a user input (e.g., gesture-drag, voice), and to continue to execute the application on an external electronic device present in the see-through screen.

According to various embodiments, the wearable device 101 of the disclosure may allow only the application that was currently being used on the wearable device 101 immediately before detecting the state change of the wearable device 101 to be continuously executed on another device.

According to various embodiments, the wearable device 101 of the disclosure, while mirroring and displaying a task being executed on an external electronic device, may suggest stopping the mirroring when heating is detected. According to an embodiment, the wearable device 101 may display a UI/UX that allows the user to select whether to mirror the corresponding function to another external electronic device or to execute the corresponding function in the wearable device 101.

According to various embodiments, the wearable device 101 of the disclosure may induce the user, upon detachment of the wearable device 101 without terminating the application, to select whether to continue the application task through the display of a nearby external device (e.g., a watch or a mobile phone), or through a connected device.

According to various embodiments, the wearable device 101 of the disclosure may display a UI/UX that recommends executing the application currently being executed in the wearable device 101 on another device by detecting a change in the user's biometric signal (e.g., information related to the user's fatigue). According to an embodiment, the user's biometric signal may be acquired based on information acquired from a wearable device such as a watch or ring, or from at least one sensor embedded in the wearable device.

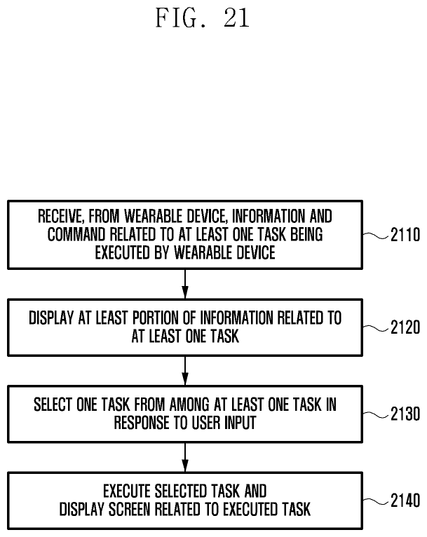

FIG. 21 is a flowchart illustrating a method for driving the electronic device according to an embodiment of the disclosure.

For example, FIG. 21 may be a flowchart describing the operations of the second electronic device 820 or the third electronic device 830 described with reference to FIG. 8.

The operations illustrated in FIG. 21 may be performed by instructions stored in memory (e.g., the memory 130 in FIG. 1). For example, when the instructions are executed by a processor (e.g., the processor 120 in FIG. 1), the instructions may cause the electronic device (e.g., the electronic device 101 in FIG. 1) to perform the operations illustrated in FIG. 21.

At least some of the operations illustrated in FIG. 21 may be omitted. Before or after at least some of the operations illustrated in FIG. 21, at least some of the operations mentioned with reference to other drawings in the disclosure may be additionally inserted.

According to an embodiment, at least some of the operations illustrated in FIG. 21 may be performed sequentially. According to an embodiment, at least some of the operations illustrated in FIG. 21 may be performed in parallel (simultaneously). According to an embodiment, at least some of the operations illustrated in FIG. 21 may be performed with the order thereof changed.

Referring to FIG. 21, a method for driving the electronic device 820 or 830 according to an embodiment will be described. In FIG. 21, the electronic device 820 or 830 may be a mobile phone, a tablet PC, a desktop PC, a laptop device, or a TV. In FIG. 21, the wearable device 101 may be referred to as a first electronic device 101, and may be a head-mount device (HMD), a headgear electronic device 820 or 830, a glasses-type electronic device 820 or 830, a video see-through or visible see-through (VST) device, an extended reality (XR) device, a virtual reality (VR) device, and/or an augmented reality (AR) device.

In operation 2110, the electronic device 820 or 830 according to an embodiment may receive information and a command related to at least one task being executed by the wearable device 101 from the wearable device 101.

In operation 2120, the electronic device 820 or 830 according to an embodiment may display at least a portion of the information related to the at least one task.

In operation 2130, the electronic device 820 or 830 according to an embodiment may select one task from among the at least one task in response to a user input.

In operation 2140, the electronic device 820 or 830 according to an embodiment may execute the selected task and display a screen related to the executed task.

The wearable device according to an embodiment of the disclosure may include a processor and memory storing instructions, and the instructions, when executed by the processor, may cause the wearable device to determine whether a state change of the wearable device has occurred using at least one sensor, determine at least one task to be executed in at least one external electronic device, and transmit information and a command related to the at least one task to the at least one external electronic device, so that the at least one external electronic device continuously executes at least a portion of the determined at least one task.

The instructions, when executed by the processor, may cause the wearable device to acquire information on a battery level or information on a power saving mode setting as an operation of determining whether the state change of the wearable device has occurred.

The instructions, when executed by the processor, may cause the wearable device to detect whether a user is wearing the wearable device using the at least one sensor as an operation of determining whether the state change of the wearable device has occurred.

The instructions, when executed by the processor, may cause the wearable device to acquire information related to eye fatigue of the user or dizziness of the user using the at least one sensor as an operation of determining whether the state change of the wearable device has occurred.

The processor may acquire the information related to the eye fatigue of the user or the dizziness of the user using artificial intelligence.

The instructions, when executed by the processor, may cause the wearable device to directly communicate with the at least one external electronic device as an operation of transmitting the information related to the at least one task.

The instructions, when executed by the processor, may cause the wearable device to deliver the information related to the at least one task to the at least one external electronic device via a server as an operation of transmitting the information related to the at least one task.

The information related to the at least one task may include context-related information of an application being executed by the wearable device, and the context-related information may include information related to an operation of a currently performed task, or information related to an operation of a task scheduled to be performed.

The information related to the operation of the task may include computation information for the operation of the task, and computation information related to artificial intelligence.

The at least one task may include a first application group for generating content, and a second application group for displaying or playing back the content generated by the first application group.

The electronic device according to an embodiment of the disclosure may include a processor and memory storing instructions, and the instructions, when executed by the processor, may cause the electronic device to receive information and a command related to at least one task being executed by the wearable device from the wearable device, display at least a portion of the information related to the at least one task, select one task from among the at least one task in response to a user input, execute the selected task, and display a screen related to the executed task.

The instructions, when executed by the processor, may cause the electronic device to display a selection menu based on the received information related to the at least one task.

The wearable device and the electronic device may be devices registered with a server through a first user account.

The wearable device and the electronic device may be devices connected to a first local network.

The wearable device and the electronic device may directly communicate with each other through short-range communication.

A method for driving the wearable device according to an embodiment of the disclosure may include: determining whether a state change of the wearable device has occurred using at least one sensor; determining at least one task to be executed in at least one external electronic device; and an operation of transmitting information and a command related to the at least one task to the at least one external electronic device, so that the at least one external electronic device continuously executes at least a portion of the determined at least one task.

The determining of whether a state change of the wearable device has occurred may include acquiring information on a battery level or information on a power saving mode setting.

The determining of whether a state change of the wearable device has occurred may include detecting whether a user is wearing the wearable device using the at least one sensor.

The determining of whether a state change of the wearable device has occurred may include acquiring information related to eye fatigue of the user or dizziness of the user using the at least one sensor.

The method may further include acquiring information related to the eye fatigue of the user or the dizziness of the user using artificial intelligence.

For one or more embodiments, at least one of the constituent elements described in one or more preceding drawings may be configured to perform one or more operations, techniques, processes, and/or methods as described in the disclosure. For example, a processor (e.g., a baseband processor) described in the disclosure, in relation to one or more preceding drawings, may be configured to operate in accordance with one or more examples described in the disclosure. As another example, a circuit associated with user equipment (UE), a base station, or a network element as described above in relation to one or more previous drawings may be configured to operate in accordance with one or more examples described herein.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device, comprising:
one or more processors; and
memory storing instructions,
wherein the instructions, when executed by the one or more processors individually or collectively, cause the wearable device to:
determine whether a state change of the wearable device has occurred using at least one sensor,
determine at least one task to be executed in at least one external electronic device, and
transmit information and a command related to the at least one task to the at least one external electronic device, so that the at least one external electronic device continuously executes at least a portion of the determined at least one task.

2. The wearable device of claim 1, wherein the instructions, when executed by the one or more processors individually or collectively, further cause the wearable device to acquire information on a battery level or information on power saving mode setting as an operation of determining whether a state change of the wearable device has occurred.

3. The wearable device of claim 1, wherein the instructions, when executed by the one or more processors individually or collectively, further cause the wearable device to detect whether a user is wearing the wearable device using the at least one sensor as an operation of determining whether a state change of the wearable device has occurred.

4. The wearable device of claim 1, wherein the instructions, when executed by the one or more processors individually or collectively, further cause the wearable device to acquire information related to eye fatigue of a user or dizziness of the user using the at least one sensor as an operation of determining whether a state change of the wearable device has occurred.

5. The wearable device of claim 4, wherein the acquiring of information related to the eye fatigue of the user or the dizziness of the user comprises acquiring the information using artificial intelligence.

6. The wearable device of claim 1, wherein the instructions, when executed by the one or more processors individually or collectively, further cause the wearable device to directly communicate with the at least one external electronic device as an operation of transmitting the information related to the at least one task.

7. The wearable device of claim 1, wherein the instructions, when executed by the one or more processors individually or collectively, further cause the wearable device to deliver the information related to the at least one task to the at least one external electronic device via a server as an operation of transmitting the information related to the at least one task.

8. The wearable device of claim 1,
wherein the information related to the at least one task includes context-related information of an application being executed by the wearable device, and
wherein the context-related information includes information related to an operation of a task currently being performed or information related to an operation of a task scheduled to be performed.

9. The wearable device of claim 8, wherein the information related to the operation of the task includes computation information for the operation of the task, and computation information related to artificial intelligence.

10. The wearable device of claim 1, wherein the at least one task includes a first application group for generating content, and a second application group for displaying or playing back the content generated by the first application group.

11. A method performed by a wearable device, the method comprising:
determining whether a state change of the wearable device has occurred using at least one sensor;
determining at least one task to be executed in at least one external electronic device; and
transmitting information and a command related to the at least one task to the at least one external electronic device, so that the at least one external electronic device continuously executes at least a portion of the determined at least one task.

12. The method of claim 11, wherein the determining of whether a state change of the wearable device has occurred includes acquiring information on a battery level or information on a power saving mode setting.

13. The method of claim 11, wherein the determining of whether a state change of the wearable device has occurred includes detecting whether a user is wearing the wearable device using the at least one sensor.

14. The method of claim 11,
wherein the method further comprises detecting detachment of the wearable device from a user, and
wherein the transmitting information and a command related to the at least one task to the at least one external electronic device is based on the detection of the detachment.

15. The method of claim 11, wherein the method further comprises:
determining that there is not a second external electronic device preconnected to the wearable device;
based on the determination that there is not a second external electronic device preconnected to the wearable device, performing a connection with a connectable second electronic device; and
transmitting the information and the command related to the at least one task to the connected second electronic device.

16. The method of claim 11, wherein the determining of whether a state change of the wearable device has occurred includes acquiring information related to eye fatigue of a user or dizziness of the user using the at least one sensor.

17. The method of claim 16, further comprising:
acquiring the information related to the eye fatigue of the user or the dizziness of the user using artificial intelligence.

18. An electronic device, comprising:
one or more processors; and
memory storing instructions,
wherein the instructions, when executed by the one or more processors individually or collectively, cause the electronic device to:
receive information and a command related to at least one task being executed by a wearable device from the wearable device,
display at least a portion of the information related to the at least one task,
select one task from among the at least one task in response to a user input,
execute the selected task, and
display a screen related to the executed task.

19. The electronic device of claim 18, wherein the instructions, when executed by the one or more processors individually or collectively, further cause the electronic device to display a selection menu based on the received information related to the at least one task.

20. The electronic device of claim 18, wherein the wearable device and the electronic device are devices registered with a server through a first user account.
